(19) United States
(12) Patent Application Publication
(10) Pub. No.: US 2025/0289950 A1
(43) Pub. Date: Sep. 18, 2025

(54) POLY(METH)ACRYLAT IMPACT MODIFIER WITH REDUCED METAL ION CONTENT AND METHOD FOR ITS PRODUCTION

(71) Applicant: Röhm GmbH, Darmstadt (DE)

(72) Inventors: Johannes Vorholz, Alzenau (DE); Ann-Kathrin Danner, Mainz (DE); Andreas Weber, Frankfurt (DE); Michael Schnabel, Biebesheim (DE); Marcus Denger, Brensbach (DE); Nadja Schinnagel, Darmstadt (DE); Nikolaos Papadopoulos, Ruesselsheim (DE)

(73) Assignee: Röhm GmbH, Darmstadt (DE)

(21) Appl. No.: 18/860,135

(22) PCT Filed: Apr. 25, 2023
(86) PCT No.: PCT/EP2023/060786

§ 371 Date: Oct. 25, 2024

(30) Foreign Application Priority Data
Apr. 28, 2022 (EP) 22170495.0

(51) Int. Cl. C08L 33/12; C08F 220/14; C08F 220/18

(52) U.S. Cl. CPC C08L 33/12; C08F 220/14; C08F 220/1804; C08F 2800/20; C08L 2203/30; C08L 2205/025; C08L 2207/53

(57) ABSTRACT

Poly(meth)acrylate impact modifiers and moulding compositions produced thereof show improved optical properties. One improved optical property is a high transparency after hot water storage. The poly(meth)acrylate impact modifiers have a reduced amount of cationic metal ions. A method to produce the poly(meth)acrylate impact modifiers polymerizes at least one multiphase alkyl (meth) acrylate polymer followed by an ion exchange step to obtain a latex having reduced the amount of cationic metal ions.

The present invention is directed to poly(meth)acrylate impact modifiers comprising at least one multiphase alkyl (meth)acrylate emulsion polymer, having a specified low amount of cationic, in particular a very low concentration of alkali metal ions, such as sodium. The impact modifiers according to the present invention and moulding composition produced thereof have improved optical properties, in particular high transparency after hot water storage.

Furthermore, the present invention is directed to a method for producing the poly (meth)acrylate impact modifier comprising the preparation of at least one multiphase alkyl (meth)acrylate polymer via emulsion polymerization, followed by an ion exchanging step of the obtained latex, e.g. using a cation and/or anion exchanger material, in combination with coagulation and mechanical dewatering, wherein the amounts of cationic metal ions, such as alkali ions, in the dewatered alkyl (meth)acrylate emulsion polymer are reduced.

The invention also relates to impact modified moulding compositions, especially impact modified poly (methyl methacrylate) (PMMA) compositions, having improved profile of properties, including good optical properties, in particular high transparency after hot water storage. The moulding compositions are preferably used for producing moulded articles and semi-finished products, such as films and sheets, in particular transparent articles and semi-finished products or products with good optical appearance.

### STATE OF THE ART

It is known that the impact resistance of moulding compositions, especially of relatively brittle synthetic resins, such as poly(meth)acrylate moulding compositions, can be improved by incorporating a suitable amount of so-called impact modifiers. It has become established practice in industry to use impact modifiers produced by emulsion polymerization, known as core, core-shell, or core-shell-shell particles. These generally includes an elastomeric phase, e.g. as core or as an intermediate shell grafted onto the core, and a hard, outer phase, which typically ensures good incorporation of the impact modifier particles into the matrix polymer. Such multiphase emulsion polymers and their preparation are for examples described in WO 2004/056893.

Typically, such impact modifiers produced by emulsion graft polymerization are obtained as aqueous polymer dispersion (latex), which needs to be worked-up via coagulation and separation of the emulsion polymer. Several methods of coagulation (also referred to as precipitation) of polymer latices are well known and described in the state of the art.

For example, it is described that emulsion polymers, such as poly(meth)acrylate impact modifiers of the present invention, can be coagulated by means of known physical coagulation processes, such as shear coagulation, thermal shear coagulation, spray drying, freeze coagulation or pressure coagulation processes, or by means of chemical coagulation processes, which includes the addition of electrolytes, in particular multivalent cations, e.g. alkaline earth metal salts, aluminium salts or zinc salts, or inorganic or organic acids.

For example, the coagulation of an aqueous polymer dispersion by means of continuous or semi-continuous freezing coagulation and the subsequent mechanical dewatering, e.g. using centrifugation step, are described in WO 2015/074883. The coagulation and dewatering of emulsion polymers via thermal shear coagulation in an extruder line are for example described in WO 2002/184539, EP 0 683 028, and EP 0 187 715.

Another common way for coagulation of emulsion polymers is mixing the emulsion polymer (latex) with a coagulant, which is often selected from aqueous solutions of metal salts, in particular bivalent or trivalent metal ions, and/or acids, such as sulfuric acid, acetic acid, phosphorus acid. For example, aqueous solutions of alkaline metal salts, alkaline earth metal salts, zinc salts or aluminium salts, such as magnesium sulfate, calcium chloride, and aluminium chloride are used as coagulants.

The document EP 2 942 360 describes a thermoplastic resin powder obtained by coagulating a polymer latex produced by means of emulsion polymerization using a phosphoric acid ester as emulsifying agent, wherein the content of free acid in the resin is not greater than 500 ppm. For example, aluminium sulfate or sulfuric acid is used as coagulants. EP 2 942 360 describes that the presence of polyvalent metal ions in the thermoplastic resin powder results in reduction of the fluidity of the thermoplastic resin powder, and therefore the amount of coagulant should be as less as possible. It is described that the thermoplastic resin powder comprises less than 50 ppm calcium, preferably less than 50 ppm calcium and magnesium in sum, and 60 to 300 ppm aluminium and more than 50 ppm phosphorus. The amount of alkali metal ions is not discussed in EP 2 942 360.

The document GB 2 226 324 A describes a clear viscous moulding composition comprising 10 to 90% of a hard phase made of methyl methacrylate and 1 to 90% of a viscous phase distributed in the hard phase, e.g. made of a crosslinked butyl acrylate polymer, wherein the moulding composition comprises not more than 0.05% by weight of water-soluble components. It is described that the aqueous phase is separated off in liquid form from the coagulate to such an extent that not more than 0.05% by weight of water-soluble constituents remain in the composition in order to ensure permanent clarity, particularly under the effect of moisture.

The document US 2021/054113 A1 describes a multilayered acrylic polymer coagulate characterized via its bulk density, particle diameter, wherein the amount of alkali and earth alkali metal N (in mmol/kg) is defined based on the glass transition temperature Tg (in ° C.) of the acetone-soluble matter of the coagulate and valency of the alkali and earth alkali metal a via the formula Σ(N/a)*(120−Tg)≤100. The multilayered acrylic polymer coagulate of D1 shall exhibit excellent transparency, resistance to hot water whitening and stress-whitening.

The document KR 2018 0069421 A describes an impact modifier capable of imparting impact strength to an epoxy resin and a method for preparing the impact modifier wherein the content of residual emulsifier and metal ions is reduced, and the coagulation is effected by addition of hydro chloric acid and lowering the pH to 3 or less. The content of metal ions should be reduced to a level of 90 ppm or less via a post-treatment step. The impact modifier described in KR 2018 0069421 A comprises a specific polyalkylene glycol-based comonomer, such as polyethyleneglycol methacrylate (PEGMA). Furthermore, a specific phosphate-based emulsifier is used in the method for preparing the impact modifier.

Furthermore, it is described in the state of the art to subject a polymer latices, e.g. fluoropolymers latices, to an ion exchanging step, for example in order to reduce the metal ion content in the polymer latex.

DE 2 046 220 A describes the separation by size of polydisperse particle dispersion by passing the dispersion through a bed of solid particles that are larger than the particles to be separated and eluting the bed with the dispersing medium in order to remove the particles from the bed according to their size. The bed of solid particles may be of glass beads or beads of cross-linked polystyrene. In this context also ion exchanger materials are utilized.

EP 0 591 888 A1 describes a process for working up aqueous dispersions of fluorinated thermoplastics which comprises substantially replacing the cations in the aqueous dispersion by hydrogen ions, compressing the dispersion, optionally after dilution with water, and coagulating the dispersion by decompressing it through small openings. Optionally, the coagulated dispersion is filtered, washed, mechanically dewatered, broken up to a free-flowing product and dried. The technical teaching of EP 0 591 888 A1 is focused on continuously working up aqueous dispersions of fluorinated thermoplastics at high throughputs, wherein optical properties are not considered.

EP 0 571 069 A2 discloses a process for improving the water-whitening resistance of pressure sensitive adhesives by removing the water-soluble ions and adjusting the pH of the pressure sensitive adhesive formulation to at least about 6.0. Deionized adhesives which had not been readjusted to a pH greater than about 6.0 do not show an improved resistance to water-whitening. The water-soluble ions are removed by contacting the aqueous latex or the adhesive formulation with an ion exchange resin, wherein preferably the cations (e.g. with sulfonic acid type cation exchanger) as well as the anions (e.g. using quaternary anion exchange resin) should be removed, e.g. using so called mixed beds ion exchangers. The amounts of cations and anions in the pressure sensitive adhesives are not mentioned in EP 0 571 069 A2.

WO 2001/57100 A1 describes the preparation of ultra clean, i.e. salt-free, fluoropolymers by aqueous emulsion polymerization, removing essentially all ions different than NH4+, H+ and OH−, and coagulating the fluoropolymer without addition of ions. The focus is on avoiding metal-free acid acceptors, i.e. strong organic bases, for applications such as curable compounds and coatings. Optical properties are not considered.

WO 2013/160029 describes a polymer composition containing at least a graft polymer produced by emulsion polymerization and optionally a thermoplastic polymer, a rubber-free vinyl(co)polymer and other polymers or polymer additives. The emulsion graft copolymer is precipitated with at least one alkaline earth metal salt in basic medium and comprises at least one sodium salt and at least one alkaline earth metal salt in a molar ratio Na/(Mg+Ca) of at least 0.10 and at most 1.0. It is described that the mouldings prepared from said emulsion graft copolymer exhibit an improved surface quality after storage under warm-humid conditions. In contrast to the present invention it is recommended to increase the amount of sodium by the addition of a sodium salt during the emulsion polymerization and/or the coagulation process.

Particularly important properties of impact modified PMMA moulding compositions are advantageous mechanical properties such as high toughness (impact resistance, notched impact resistance), high elasticity (modulus of elasticity), as well as good processability (thermoplastic flowability, MVR), and good weathering and heat resistance. Furthermore, a fundamental requirement placed upon PMMA moulding compositions and articles is optical transparency even at elevated temperature or after exposure to hot water. Generally, products that are considered to be optically clear are those with a haze value smaller than or equal to 15.0%, in particular below 10.0% and very particularly below 6.0%, measured by means of a BYK Gardner Hazegard-plus hazemeter at 23° C. on test specimen having a thickness of 1 mm according to standard ASTM D1003 (2013).

Often it is a problem that the impact modified PMMA moulding compositions and articles made thereof show reduced transparency and become milky white after storage in hot water, in particular after 10-24 hours in water of 80° C. Thus, there is a great need to provide impact modified PMMA moulding compositions showing reduced haze and high optical transmission after hot water storage.

### OBJECT OF THE INVENTION

One object of the invention is to provide a poly(meth)acrylate impact modifier, as well as moulding compositions, moulded articles and semi-finished products, such as films and sheets, comprising the poly(meth)acrylate impact modifier, which have improved optical properties, in particular high transparency and high transmission. Particularly, the impact modifier should cause lower haze values as per ASTM D 100-13, in particular after hot water storage at 70° C.-80° C., compared to the prior art modifiers. Further, the impact modifier should exhibit high optical transmission values, even after hot water storage at 70° C.-80° C., e.g. for 4-24 hours. Particularly, it is an object of the invention to provide an impact modifier or semi-finished products, preferably transparent semi-finished products, which have a haze, measured at 23° C. on test specimen having a thickness of 1 mm according to standard ASTM D1003 (2013), of ≤40%; preferably ≤30%, preferably ≤20%, after hot water storage at 70° C., preferably after hot water storage at 80° C., e.g. for 4-24 hours.

Another object of the invention is to provide a cost effective and easy process for producing the improved poly(meth)acrylate impact modifiers and/or impact modified polymer compositions.

### Solution According to the Invention

It was surprisingly found that the haze after hot water storage of impact modifiers or transparent articles made thereof is negatively affected by the presence of ionic species, in particular alkali metal ions. It was found that the haze after hot water storage is reduced, if the total amount of cationic metal ions, in particular alkali metal ions, in the impact modifier, in particular after coagulation and dewatering, is reduced to or under a critical value of about 4.5 mmol/kg, preferably 3.0 mmol/kg, more preferably 1.0 mmol/kg, based on dry impact modifier. Further, typically the inventive impact modifier and test specimens comprising it show high optical transmission values, even after hot water storage.

Preferably, reduction of ionic species, in particular alkali metal ions, can be carried out via ion exchange step. Furthermore, it is possible to reduce the amount of metal ions, in particular alkaline metal ions, via known washing, dilution and/or dewatering steps. It has been surprisingly found that it is possible to add a defined amount of alkaline earth salts as coagulant after ion exchange step in order to assist coagulation without impairment of haze after hot water storage.

Typically, said cationic metal ions, such as alkali metal ions or multivalent metal ions (e.g. alkaline earth metal, zinc and aluminium) results from additives, such as emulsifiers, initiators and buffers, used in emulsion polymerization. Generally, the content of ionic species in the coagulated polymer can be reduced by washing and/or by a higher degree of dewatering. However, such washing procedure is time and cost consuming and produced large amount of washing water. In this context it was surprisingly found, that such desired low amount of cationic metal ions, in particular alkali metal ions, can be easily and advantageously obtained by an ion exchange step, e.g. using cation exchange material (typically including acidic groups, e.g. sulfonic acid groups) and optionally anion exchanger material (typically including basic groups, e.g. such as quaternary ammonium groups). It was found that the polymer latex of the multiphase alkyl (meth)acrylate polymer obtained after emulsion polymerisation remains stable during such ion exchange step and shows no coagulation. Thus, the hot water storage stability of the impact modifier or compositions thereof can be improved if an additional ion exchange step is carried out before coagulation.

### DESCRIPTION OF THE INVENTION

The present invention is directed to a poly(meth)acrylate impact modifier (also referred to as impact modifier in the following) comprising (preferably consisting essentially of) at least one multiphase alkyl (meth)acrylate emulsion polymer (also referred to as emulsion polymer in the following), wherein the total amount of alkali metal ions, preferably sodium and/or potassium, in the impact modifier is less than or equal to 4.5 mmol/kg, preferably less than or equal to 3.0 mmol/kg, more preferably less than or equal to 2.0 mmol/kg, based on the solid content of the impact modifier.

In a preferred embodiment the poly(meth)acrylate impact modifier comprises less than or equal to 1.0 mmol/kg, preferably less than or equal to 0.9 mmol/kg, more preferably less than or equal to 0.5 mmol/kg, based on the solid content of the impact modifier, of alkali metal ions, preferably sodium and/or potassium.

More preferably, the poly(meth)acrylate impact modifier comprises from 0 to 4.5 mmol/kg, preferably from 0 to 3.0 mmol/kg, more preferably from 0 to 1.0 mmol/kg, preferably from 0.01 to 4.5 mmol/kg, also preferably from 0.01 to 3.0 mmol/kg, also preferably from 0.01 to 1.0 mmol/kg, based on the solid content of the impact modifier, of alkali metal ions.

Preferably, the inventive poly(meth)acrylate impact modifier comprises less than or equal to 20.0 mmol/kg, preferably less than or equal to 10.0 mmol/kg, more preferably less than or equal to 9.0 mmol/kg, based on the solid content of the impact modifier, of cationic metal ions (i.e. sum of all cationic metal ions, e.g. alkali metal ions and multivalent ions, such as alkaline earth metal ions, aluminium ions and/or zinc ions). Typically, the total amount of cationic metal ions (e.g. alkali metal ions, alkaline earth metal ions, aluminium ions and/or zinc ions) is in the range from 0.1 to 20.0 mmol/kg, preferably from 0.4 to 10.0 mmol/kg.

Preferably, the inventive poly(meth)acrylate impact modifier comprises less than or equal to 6.5 mmol/kg, preferably less than or equal to 5.0 mmol/kg, more preferably based on the solid content of the impact modifier, of sulphur (calculated as sulfate). Typically, the impact modifier comprises less than or equal to 6.5 mmol/kg, preferably less than or equal to 5.0 mmol/kg, based on the solid content of the impact modifier, of sulphur containing anions (calculated as sulfate).

Typically, the metal ions (e.g. alkali metal ions and/or multivalent metal ions, selected from alkaline earth metals, zinc and aluminium) contained in the inventive impact modifiers arise from auxiliaries used in the emulsion polymerization process of the multiphase alkyl (meth)acrylate emulsion polymer, such as initiators, surfactants, and buffer salts. Furthermore, metal ions may arise from additives, such as stabilizers, added to the impact modifier. In particular, the alkali metal ions included in the inventive impact modifier arise from initiators and/or surfactants used in emulsion polymerization.

Typically, a significant amount of metal ions in the impact modifier may arise from coagulants used for isolation of the emulsion polymer from the aqueous latex dispersion. Thus, the multiphase alkyl (meth)acrylate emulsion polymer of the inventive impact modifier is preferably coagulated without the addition of coagulants, e.g. a metal salt. Typically, the coagulation is carried out by means of physical coagulation. Furthermore, it is possible to carry out the coagulation by means of physical coagulation together with the addition of at least one coagulant, selected from multivalent metal ions, such as calcium salts, magnesium salts and/or aluminium salts.

According to a preferred embodiment the coagulation of the multiphase alkyl (meth)acrylate emulsion polymer is carried out by means of physical coagulation without addition of a coagulant, e.g. selected from multivalent metal ions. For example, the poly(meth)acrylate impact modifier comprises less than or equal to 4.5 mmol/kg, preferably less than or equal to 3.0 mmol/kg, more preferably less than or equal to 2.0 mmol/kg, also preferably less than or equal to 1.0 mmol/kg, based on the solid content of the impact modifier, of cationic metal ions (i.e. sum of all cationic metal ions, e.g. alkali metal ions and multivalent ions, such as alkaline earth metal ions). For example, the poly(meth)acrylate impact modifier may comprise sodium ions and/or potassium ions, and the amounts of all other cationic metal ions are below the limit of detection of the respective analysis method.

According to another preferred embodiment, at least one multivalent metal salt (e.g. alkaline earth metal salt, aluminium salt and/or zinc salt) is added as coagulants, and the poly(meth)acrylate impact modifier comprises less than 4.5 mmol/kg, preferably less than 3.0 mmol/kg, more preferably less than 1.0 mmol/kg, based on the solid content of the impact modifier, in sum of alkali metal ions and from 0.4 to 15.0 mmol/kg, preferably from 0.5 to 10.0 mmol/kg, based on the solid content of the impact modifier, of multivalent metal ions (e.g. alkaline earth metal ions, aluminium ions and/or zinc ions).

The term “multivalent metal” or “multivalent metal ion” is directed to metal ions having two or more, preferably two or three, ionic charges. Preferably, multivalent metal ions may be selected from metals of the IUPAC group 2 (alkaline earth metals) and the IUPAC groups 8 to 14, more preferably from metals of the IUPAC group 2 (alkaline earth metals), the IUPAC group 12 (zinc group) and the IUPAC group 13 (boron group).

The term “alkali metal” or “alkali metal ion” includes the elements of IUPAC group 1 of the periodic table of elements, in particular lithium (Li), sodium (Na), and potassium (K). The term “alkaline earth metal” or “alkaline earth metal ion” includes the elements of IUPAC group 2 of the periodic table of elements, in particular magnesium (Mg), calcium (Ca), strontium (Sr) and barium (Ba).

The term “(meth)acrylate” as used herein is meant to encompass methacrylates, acrylates and mixtures thereof.

The term “alkyl (meth)acrylate polymer” means a polymer comprising at least 30% by weight, preferably at least 40% by weight, more preferably at least 50% by weight, of alkyl (meth)acrylate monomer units and includes copolymers of alkyl (meth)acrylate monomers with one or more other co-polymerizable monomer.

The term “alkyl (meth)acrylate emulsion polymer” means a multiphase emulsion polymer comprising at least 30% by weight, preferably at least 40% by weight, more preferably at least 50% by weight, of alkyl (meth)acrylate monomer units in the outer shell, wherein the outer shell may include copolymers of alkyl (meth)acrylate monomers with one or more other co-polymerizable monomer, for example styrene.

The term “aqueous” or “aqueous solution” means that the medium or solvent consists of water or comprises water as main component. For example, a polar water-miscible co-solvent, e.g. alcohol, may be included in the medium or solvent.

The term “latex” used in connection with the present invention means water-insoluble polymer with is dispersed in an aqueous phase, preferable stabilized by one or more surfactants, and which is prepared by conventional polymerization techniques, preferably by emulsion polymerization.

If not defined otherwise, the term ppm means weight-based ppm, such as mg/kg, according to the present invention. For example, the term ppm means mg/kg, based on the solid content of the poly(meth)acrylate impact modifier.

The content of metal ions, e.g. alkaline metals and alkaline earth metals, in the emulsion polymer or in the impact modifier is typically determined via atom emission spectroscopy after chemical digestion of the polymer sample, for example after microwave-assisted digestion of the polymer sample in nitric acid. The amount of alkali metal and multivalent metal, e.g. alkaline earth metal or aluminium, is given in consideration of the typical limit of detection of the respective analysis method. For example, an amount given with 0% by weight, 0 ppm or 0 mmol/kg is understood as being below the limit of detection of the respective analysis method.

Preferably, multivalent metal ions are selected from metal ions from IUPAC group 2 (alkaline earth metals), IUPAC groups 12 (zinc group) and IUPAC group 13 (boron group). More preferably, the multivalent metal ion is selected from alkaline earth metals, preferably magnesium (Mg) and/or calcium (Ca), and metals of the IUPAC group 13, preferably aluminium. Most preferably the multivalent metal ion is selected from alkaline earth metals, zinc (Zn), and aluminium (Al). In a further preferred embodiment, the at least on multivalent metal ion is selected from magnesium (Mg), calcium (Ca), zinc (Zn) and aluminium (Al), more preferably from magnesium (Mg), calcium (Ca) and aluminium (Al).

In particular the total amount of cationic metal ions is directed to the sum of all metal ions present in the poly(meth)acrylate impact modifier. In particular the total amount of cationic metal ions includes alkali metal ions and multivalent metal ions, e.g. alkaline earth metal ions and/or aluminium ions. In particular the amount of alkali metal ions is directed to the sum of all alkali metal ions present in the poly(meth)acrylate impact modifier. Preferably, the alkali metal ions are sodium ions and/or potassium ions and the amount of alkali metal ions is directed to the sum of sodium ions and potassium ions.

The cationic metal ions, e.g. the alkali metal ions, may be present in the impact modifier in any arbitrary form, such as in form of a solid salt or salt inclusion, dissolved in an aqueous phase, bound or adsorbed to other components or groups, e.g. anionic groups, of the emulsion polymer.

Typically, impact modifier comprises or essentially consists of polymer particles which are prepared by emulsion polymerization. After emulsion polymerization said impact modifier is in the form of an aqueous polymer dispersion at the end of the synthesizing step. This aqueous polymer dispersion is also referred to as latex and contains not only the polymer fraction but also polar, water-soluble auxiliary materials, such as surfactants, buffer substances, initiators and other redox components, that are added in polymerization step.

### Multiphase Alkyl (Meth)Acrylate Emulsion Polymer

Preferably, the multiphase alkyl (meth)acrylate emulsion polymer is an emulsion polymer obtained by emulsion polymerization, preferably by sequentially emulsion polymerization, of alkyl (meth)acrylate monomers and optionally other copolymerizable monomers, wherein the emulsion polymer has a multiphase structure, which comprises at least one core and at least one, preferably one or two, shells.

For example, the multiphase alkyl (meth)acrylate emulsion polymer may be formed by crosslinked particles having core-shell structure or core-shell-shell structure. Typically, the particles have an average particle diameter between 20 nm and 500 nm, preferably between 50 nm and 450 nm, more preferably between 100 nm and 400 nm and most preferably between 150 nm and 350 nm.

Average particle diameter can be determined by a method known to a skilled person, e.g. via static or dynamic light scattering, such as laser diffraction measurements or photon correlation spectroscopy according to DIN ISO 13321:1996. Typically, volume-averaged particle diameters can be obtained from light scattering measurements.

In one preferred embodiment the multiphase alkyl (meth)acrylate emulsion polymer comprises a soft, elastomeric core and a hard, non-elastomeric outer phase, which is produced in the presence of the core, typically via graft emulsion polymerization. Said multiphase alkyl (meth)acrylate emulsion polymer is referred to as core-shell emulsion polymer in the following.

In another preferred embodiment the multiphase alkyl (meth)acrylate emulsion polymer comprises a hard, non-elastomeric core; a soft, elastomeric intermediate shell, which is produced in the presence of the core, typically via graft emulsion polymerization, and a hard, non-elastomeric outer shell, which is produced in the presence of the intermediate core-shell particles, typically via graft emulsion polymerization. Said multiphase alkyl (meth)acrylate emulsion polymers are referred to as core-shell-shell emulsion polymers in the following.

Preferably, the outer shell of the multiphase emulsion polymer is a hard phase comprising at least 80% by weight, based on the outer shell, at least one C₁-C₆ alkyl methacrylate, preferably at least 80% by weight, based on the outer shell, of methyl methacrylate.

Preferably, at least 50% by weight, more preferably at least 55% by weight, more preferably at least 80% by weight, based on the total weight of the emulsion polymer, of the outer layer is covalently bonded to the soft phase, i.e. soft core of core-shell emulsion polymer or intermediate shell of core-shell-shell emulsion polymer. Typically, the amount of covalently bonded outer layer (grafted polymer) (or also referred to as degree of grafting) is determined as being the amount insoluble in acetone.

In order to determine the degree of grafting the water of the emulsion polymer dispersion is removed in a drying cabinet resulting in a solid of pure modifier. 1.5 g of multiphase emulsion polymer is mixed with 40 g of acetone and stirred at 40° C. until a cloudy solution is obtained (2-3 h). The insoluble, grafted polymer is separated via centrifugation (e.g. 9000 rpm, 2-5 h) and the clear supernatant is dried to constant weight leading to the amount of the soluble fraction. Therewith, the degree of grafting is calculated applying formula (1).

Degree of grafting=100%−acetone soluble content (1)

Preferably, the degree of grafting of the emulsion polymer is in the range of 50 to 100%, preferably 52 to 99% by weight, based on the solid content of the emulsion polymer.

Preferably, the alkyl (meth)acrylate emulsion polymer comprises at least 60% by weight, preferably at least 75% by weight, based on the total emulsion polymer, of at least one C₁-C₂₀ alkyl (meth)acrylate, more preferably methyl methacrylate and/or n-butyl acrylate.

Generally, (meth)acrylates include C₁-C₁₀-alkyl (meth) acrylates, C₂-C₂₀-alkenyl (meth)acrylates, C₆-C₂₀ aryl (meth)acrylates, C₆-C₂₀ aralkyl (meth)acrylates, C₁-C₁₀ hydroxyalkyl (meth)acrylates, glycol di(meth)acrylates, and polyfunctional (meth)-acrylates.

Preferably the emulsion polymer comprises at least one C₁-C₁₀ alkyl methacrylate, preferably selected from methyl methacrylate, ethyl methacrylate, propyl methacrylate, isopropyl methacrylate, n-butyl methacrylate, isobutyl methacrylate, tert-butyl methacrylate, pentyl methacrylate, hexyl methacrylate, heptyl methacrylate, octyl methacrylate, isooctyl methacrylate and ethylhexyl methacrylate, and also cycloalkyl methacrylates, such as cyclohexyl methacrylate.

Preferably the emulsion polymer comprises at least one C₁-C₁₀ alkyl acrylate, preferably selected from methyl acrylate, ethyl acrylate, propyl acrylate, isopropyl acrylate, n-butyl acrylate, isobutyl acrylate, tert-butyl acrylate, pentyl acrylate, hexyl acrylate, heptyl acrylate, octyl acrylate, isooctyl acrylate, and ethylhexyl acrylate, and also cycloalkyl acrylates, such as cyclohexyl acrylate.

Further, it is possible that the emulsion polymer comprises at least one conjugated diene, such as butadiene, in particular as a soft core.

Particularly, the multiphase alkyl (meth)acrylate emulsion polymer comprises (preferably consists of:
at least 10% by weight, preferably at least 20% by weight, preferably 10 to 70% by weight, of at least one C₁-C₁₀, preferably C₁-C₆ alkyl methacrylate, preferably methyl methacrylate;
5 to 80% by weight, preferably 20 to 80% by weight, of at least one C₁-C₁₀ alkyl acrylate (preferably n-butyl acrylate) or at least one conjugated diene (preferably butadiene);
0 to 2% by weight, preferably 0.1 to 2% by weight, more preferably 0.5 to 1% by weight, of at least one crosslinking monomer, preferably a polyfunctional (meth)acrylate and/or allyl (meth)acrylate; and
0 to 15% by weight, preferably 0.5 to 10% by weight, more preferably 0.5 to 5% by weight, of optionally further monomers, preferably different from the monomers mentioned above, for example vinyl aromatic monomers, e.g. styrene, α-methylstyrene or benzyl methacrylate, preferably styrene.

More particularly, the multiphase alkyl (meth)acrylate emulsion polymer comprises (preferably consists of):
at least 40% by weight, preferably 40 to 70% by weight, of at least one C₁-C₁₀, preferably C₁-C₆ alkyl methacrylate, preferably methyl methacrylate;
5 to 45% by weight, preferably 20 to 45% by weight, preferably 25 to 42% by weight, of at least one C₁-C₁₀ alkyl acrylate, preferably C₁-C₆ alkyl acrylate, preferably selected from ethyl acrylate, methyl acrylate, 2-ethylhexyl acrylate and butyl methacrylate, more preferably the C₁-C₁₀ alkyl acrylate includes n-butyl acrylate;
0 to 2% by weight, preferably 0.1 to 2% by weight, more preferably 0.5 to 1% by weight, of at least one crosslinking monomer, preferably a polyfunctional (meth)acrylate and/or allyl (meth)acrylate; and
0 to 15% by weight, preferably 0 to 12% by weight, more preferably 0.5 to 10% by weight, of optionally further monomers, preferably different from the monomers mentioned above, for example vinyl aromatic monomers, e.g. styrene, benzyl methacrylate.

The amounts are given based on the total mass of monomers.

It is preferred that the multiphase alkyl (meth)acrylate emulsion polymer comprises vinyl aromatic monomers, e.g. styrene and/or C₇-C₂₀ aralkyl (meth)acrylates, such as benzylmethacrylate, in order to adjust the differences of the refractive index of the hard and the soft phase. Styrenes which may be used are styrene, substituted styrenes with an alkyl substituent in the side chain, e.g. α-methylstyrene and α-ethylstyrene, substituted styrenes with an alkyl substituent on the ring, such as vinyltoluene and p-methylstyrene, and halogenated styrenes, such as monochlorostyrenes, dichlorostyrenes, tribromostyrenes and tetrabromostyrenes.

Typically, the crosslinking monomer has two or more polymerizable double bonds in the molecule. The crosslinking monomer may be selected from bifunctional (meth)acrylates, tri- or multifunctional (meth)acrylates, and other known crosslinkers, such as allyl methacrylate, allyl acrylate, and divinylbenzenes.

For example, bifunctional (meth) acrylates are di-esters of (meth)acrylic acid and a poly-functional alcohol, e.g. di(meth)acrylate of propane diol, butane diol, hexane diol, octane diol, nonane diol, decane diol, eicosane diol, ethylene glycol, diethylene glycol, triethylene glycol, tetraethylene glycol, dodecaethylene glycol, tetradecaethylene glycol, propylene glycol, dipropyl glycol, tetradecapropylene glycol. For example, tri- or multi-functional (meth) acrylates are tri- or multi-esters of (meth)acrylic acid and a poly-functional alcohol, e.g. trimethylolpropane tri(meth)acrylates and pentaerythritol tetra (meth)acrylate.

Suitable cross-linking monomers are for example describes in WO 02/20634 and EP 0 522 351.

Preferably, the alkyl (meth)acrylate emulsion polymer comprises at least one crosslinking monomer selected from ethylene glycol dimethacrylate, 1,4-butanediol dimethacrylate, divinylbenzene, and allyl (meth)acrylate. More preferably the crosslinking monomer is allyl methacrylate.

The alkyl (meth)acrylate emulsion polymer may comprise 0 to 15% by weight, preferably 0 to 10% by weight, more preferably 0.5 to 5% by weight, based on the solid content of the emulsion polymer, of further components, such as auxiliaries or residues of auxiliaries added during polymerisation and/or subsequent processing, for example emulsifiers, initiators, buffers or molecular weight regulators as mentioned below. In particular the alkyl (meth)acrylate emulsion polymer may comprise 0 to 15% by weight, preferably 0.001 to 10% by weight, more preferably 0.01 to 5% by weight, based on the solid content of the emulsion polymer, of molecular weight regulators, for example as described below.

### Core-Shell Emulsion Polymer

For example, the impact modifier is based on a two-phase emulsion polymer, which is composed of a soft, elastomeric core and a hard shell, for examples described in EP 0 528 196, DE 38 42 796, DE 10 2005 062 687. In particular said core-shell emulsion polymers are obtainable via a two-step emulsion polymerization in water for example as described in DE-A 38 42 796. The core particles are prepared via emulsion polymerization in a first step and the shell is prepared via emulsion polymerization of a monomer mixture in the presence of the core particles.

Typically, the hard phase has a glass transition temperature T_{g} above 70° C. and comprises from 80 to 100% by weight, based on the hard phase of methyl methacrylate. Typically, the soft core has a glass transition temperature T_{g} below −10° C. and comprises from 50 to 99.5% by weight, based on the soft core, of a C₁-C₁₀ alkyl acrylate and from 0.5 to 5% by weight of a crosslinking monomer. Further, the soft core may have a glass transition temperature T_{g} below −10° C. and may comprise from 50 to 100% by weight, based on the soft core, of at least one conjugated diene, e.g. butadiene.

In a preferred embodiment the multiphase alkyl (meth)acrylate emulsion polymer is a core-shell emulsion polymer comprising (preferably consisting of):
A1) 10 to 95% by weight, based on the total emulsion polymer, of a soft elastomeric core A1, having a glass transition temperature T_{g} below −10° C., which is built up from:
   A1.1) 50 to 99.5% by weight, based on A1, of at least one C₁-C₁₀ alkyl acrylate, preferably n-butyl acrylate;
   A1.2) 0.5 to 5% by weight, based on A1, of at least one crosslinking monomer, having two or more ethylenically unsaturated groups; and
   A1.3) 0 to 10% by weight, based on A1, of at least one further ethylenically unsaturated, free radically polymerizable monomer; and
B1) 5 to 90% by weight, based on the total emulsion polymer, of a hard shell B1, having a glass transition temperature T_{g} above 70° C., which is built up from:
   B1.1) 80 to 100% by weight, based on B1, of at least one C₁-C₆ alkyl methacrylate, preferably methyl methacrylate, and
   B1.2) 0 to 20% by weight, based on B1, of at least one further ethylenically unsaturated, free radically polymerizable monomer, e.g. selected from C₁-C₆ alkyl acrylate, such as butyl acrylate or ethyl acrylate.

In another preferred embodiment the multiphase alkyl (meth)acrylate emulsion polymer is a core-shell emulsion polymer comprising (preferably consisting of):
A1) 50 to 90% by weight, based on the total emulsion polymer, of a soft elastomeric core A1, having a glass transition temperature T_{g} below −10° C., which is built up from:
   A1.1) 90 to 100% by weight, based on A1, of at least one conjugated diene, preferably butadiene;
   A1.2) 0 to 5% by weight, based on A1, of at least one crosslinking monomer, having two or more ethylenically unsaturated groups; and
   A1.3) 0 to 10% by weight, based on A1, of at least one further ethylenically unsaturated, free radically polymerizable monomer, e.g. at least one vinyl aromatic monomer, preferably styrene and/or α-methylstyrene; and
B1) 10 to 50% by weight, based on the total emulsion polymer, of a hard shell B1, having a glass transition temperature T_{g} above 70° C., which is built up from:
   B1.1) 70 to 90% by weight, based on B1, of at least one C₁-C₆ alkyl methacrylate, preferably methyl methacrylate, and
   B1.2) 10 to 30% by weight, based on B1, of at least one further ethylenically unsaturated, free radically polymerizable monomer, e.g. selected from vinyl aromatic monomers, preferably styrene and/or α-methylstyrene.

Preferably, the degree of grafting of the core-shell emulsion polymers is at least 50% by weight, preferably from 50 to 60% by weight, based on the total solid content of the emulsion polymer.

Generally, the glass transition temperature T_{g} of the polymer or the phases of the multiphase emulsion polymer can be determined in a known manner by differential scanning calorimetry (DSC). The glass transition temperature T_{g} may also be calculated as an approximation by means of the Fox equation.

Core-Shell-Shell Emulsion Polymer For example the impact modifier is based on a three phase emulsion polymer, which is composed of a hard core, that is for example build up from crosslinked methyl methacrylate, a soft intermediate shell, which is for example build up from crosslinked C₁-C₁₀ alkyl acrylate, preferably n-butyl acrylate; and a hard, outer shell, that is for example built up from non-crosslinked methyl methacrylate. Typically, said core-shell-shell emulsion polymers are produced as described in EP 1 332 166 B1, WO 02/20634 and EP 0 522 351.

In particular the poly(alkyl)methacrylate impact modifier may comprise a methacrylate/butadiene/styrene copolymer or an acrylate/methacrylate copolymer.

In a preferred embodiment the multiphase alkyl (meth)acrylate emulsion polymer is a core-shell-shell emulsion polymer comprising (preferably consisting of)
A2) 5 to 40% by weight, based on the total emulsion polymer, of a hard, non-elastomeric core A2, having a glass transition temperature T_{g} above 50° C., which is built up from:
   A2.1) 80 to 100% by weight, based on A2, of at least one C₁-C₆ alkyl methacrylate, preferably of methyl methacrylate;
   A2.2) 0 to 20% by weight, based on A2, of at least one further ethylenically unsaturated, free radically polymerizable monomer; and
   A2.3) 0 to 5% by weight, based on A1, of at least one crosslinking monomer, having two or more ethylenically unsaturated groups;
B2) 20 to 75% by weight, based on the total emulsion polymer, of a soft elastomeric intermediate shell B2, having a glass transition temperature T_{g} below 0° C., which is built up from:
   B2.1) 45 to 99.5% by weight, based on B2, of at least one C₁-C₁₀ alkyl acrylate, preferably n-butyl acrylate;
   B2.2) 0.5 to 5% by weight, based on B2, of at least one crosslinking monomer, having two or more ethylenically unsaturated groups; and
   B2.3) 0 to 50% by weight, based on B2, of at least one further ethylenically unsaturated, free radically polymerizable monomer, preferably a monomer having an aromatic group; and
C2) 15 to 60% by weight, based on the total emulsion polymer, of a hard outer shell C2, having a glass transition temperature T_{g} above 50° C., which is built up from:
   C2.1) 80 to 100% by weight, preferably 90 to 100% by weight, based on C2, of at least one C₁-C₆ alkyl methacrylate, preferably methyl methacrylate; and
   C2.2) 0 to 20% by weight, preferably 0 to 10% by weight, based on C2, of at least one further ethylenically unsaturated free radically polymerizable monomer.

Preferably, at least 15% by weight, more preferably at least 25% by weight of the hard outer shell C2 are covalently bonded to the soft elastomeric intermediate shell B2.

Preferably, the degree of grafting of the core-shell-shell emulsion polymers is at least 50% by weight, preferably from 70 to 99% by weight, based on the total solid content of emulsion polymer.

### Method for Producing the Poly(Meth)Acrylate Impact Modifier

Further, the present invention is directed to a method for producing a poly(meth)acrylate impact modifier comprising at least one multiphase alkyl (meth)acrylate emulsion polymer, encompassing the following steps:
(i) preparation of at least one multiphase alkyl (meth)acrylate emulsion polymer via emulsion polymerization, in particular via sequentially emulsion polymerization, wherein the multiphase alkyl (meth)acrylate emulsion polymer is obtained in form of a latex;
(ii) removing cations and optionally anions in an ion exchanging step, wherein the latex obtained in step (i) is brought in contact with an ion exchange material, preferably a cation exchange material, more preferably a cation exchange material in protonated form;
(iii) coagulation and dewatering, preferably mechanical dewatering, of the latex obtained in step (ii), wherein the coagulation is carried out by means of physical coagulation, wherein a dewatered alkyl (meth)acrylate emulsion polymer is obtained, and wherein the dewatered alkyl (meth)acrylate emulsion polymer comprises less than or equal to 4.5 mmol/kg, preferably less than or equal to 3.0 mmol/kg, more preferably less than or equal to 2.0 mmol/kg, even more preferably less than or equal to 1.0 mmol/kg, based on the solid content of the impact modifier, of alkali metal ions, such as sodium and/or potassium.

The preferred embodiments as described above in connection with the inventive impact modifier apply to the inventive process accordingly.

In particular the dewatered alkyl (meth)acrylate emulsion polymer obtained in step (iii) comprises less than or equal to 20.0 mmol/kg, preferably less than or equal to 10.0 mmol/kg, more preferably less than or equal to 9.0 mmol/kg, based on the solid content of the impact modifier, of cationic metal ions.

In particular the poly(meth)acrylate impact modifier comprising or preferably essentially consisting of the multiphase alkyl (meth)acrylate emulsion polymer can be obtained as dried polymer powder, in particular after dewatering and drying.

In particular the poly(meth)acrylate impact modifier comprising or preferably essentially consisting of the multiphase alkyl (meth)acrylate emulsion polymer can be obtained in form of a polymer granulate. For example, the polymer powder obtained after drying may be granulated, optionally under addition of one or more additives and/or of one or more additional polymeric components, e.g. by means of a commonly known melt extrusion process. Further, it is possible that the impact modifier is obtained in form of a polymer granulate, wherein coagulation and dewatering in step (ii) is carried out by means of thermal shear coagulation in an extruder.

In a preferred embodiment the coagulation is carried out by means of freeze coagulation, wherein the aqueous phase of the coagulated emulsion polymer is at least partially removed via mechanical dewatering, for example in a centrifugation step. Typically, the water content of said dewatered emulsion polymer is in the range of 5 to 40% by weight, preferably 7 to 30% by weight, based on the dewatered emulsion polymer. In a preferred embodiment the coagulation and dewatering in step (ii) is carried out as described in WO 2015/074883.

Preferably, step (ii) may encompass a sintering step as described below. Further, the inventive method may encompass one or more washing steps (iii) and/or one or more drying steps (iv) as described below.

In a preferred embodiment the coagulation and dewatering in step (ii) is carried out via extrusion. Typically, the latex obtained by emulsion polymerization is introduced into an extruder, which typically comprises a coagulation zone, a dewatering zone and a devolatilization zone. Preferably, the coagulation and dewatering via extrusion can be carried out as described in WO 02/18453, EP 0 683 028 or EP 0 187 715.

In another preferred embodiment the coagulation and dewatering in step (ii) is carried out via freeze coagulation. Preferably, the coagulation and dewatering via freeze coagulation can be carried out as described in WO 2015/074883.

### Emulsion Polymerization Step (i)

The inventive method encompasses the emulsion polymerization step (i), wherein at least one multiphase alkyl (meth)acrylate polymer is prepared via emulsion polymerization, in particular via sequentially emulsion polymerization, and the multiphase alkyl (meth)acrylate emulsion polymer is obtained in form of a latex.

The multiphase emulsion polymer is prepared in an aqueous phase in the usual way by two, three or multi-stage emulsion polymerization. Typically, the stages of emulsion polymerization are carried out at a temperature in the range of 20 to 100° C., preferably of 60 to 90° C.

Generally, the core is created via emulsion polymerization in the first stage. Typically, the core has an average particle size from 50 to 150 nanometres (nm) for core-shell-emulsion polymers, and from 100 to 300 nanometres (nm) for core-shell-shell emulsion polymers. Methods for adjusting the desired particle size are known to the skilled person. Advantageously, control of particle size is carried out according to the seed latex method, for example described in US 2007/0123610 A1 and WO 2004/056893.

In case of core-shell emulsion polymers, the hard outer phase is prepared in the second polymerization stage in the presence of the soft core after conclusion of the first polymerization stage.

In case of core-shell-shell emulsion polymers, the elastomer intermediate phase is prepared in the second polymerization stage in the presence of the core after conclusion of the first polymerization stage. Finally, in the third stage, after the second polymerization stage is concluded, the final rigid phase is created in the same way in the presence of the emulsion polymer of the second stage.

The emulsion polymerization is suitably carried out in the presence of anionic emulsifiers. Commonly known anionic emulsifiers are for example alkyl sulfates, alkylsulfonates, alkyl sulfonic acids, aralkylsulfonates, soaps of saturated or unsaturated fatty acids. Preferably an anionic emulsifier, selected from sulfonates, alkyl sulfosuccinates, and alkoxylated and sulfated paraffins, and mixtures thereof, is used.

Preferably, the emulsion polymer latex is polymerized by aqueous free-radical emulsion polymerization. The reaction is typically initiated via water-soluble or oil-soluble free-radical polymerization initiators.

For example suitable polymerization initiators are selected from inorganic or organic peroxides, such as dilauroyl peroxide, tert-butyl peroctoate, tert-butyl perisononanoate, dicyclohexyl peroxidicarbonate, dibenzoyl peroxide and 2,2-bis(tert-butylperoxy)butane; azo compounds, such as 2,2′-azobis(isobutyronitrile) and 2,2′-azobis(2,4-di-methylvaleronitrile), and redox initiator systems. Examples of suitable redox systems are combinations of tertiary amines with peroxides or sodium disulphite and persulfates of potassium, sodium or ammonium or preferably peroxides.

Also preferred is to carry out the polymerization with a mixture of various polymerization initiators of differing half-life times, for example dilauroyl peroxide and 2,2-bis(tert-butylperoxy)butane, in order to hold the flow of free radicals constant during the course of the polymerization or else at various polymerization temperatures.

The polymerization initiator is typically used in an amount of from 0.01 to 2% by weight, based on the monomer mixture. Typically, the polymerization initiator is used in the range of 0.01 to 0.5% by weight, based on the aqueous emulsion polymerization mixture.

Preferably alkali metal peroxodisulfates or ammonium peroxodisulfates are used as polymerization initiators, for example from 0.01 to 0.5% by weight, based on the aqueous phase of polymerization mixture, wherein the polymerization is preferably initiated at temperatures from 20° C. to 100° C.

Preferably redox systems are used as polymerization initiators, for example from 0.01 to 0.05% by weight of organic hydroperoxides and 0.05 to 0.15% by weight of sodium hydroxymethylsulfonate (e.g. Rongalite®), each based on the aqueous phase of polymerization mixture, wherein the polymerization is preferably initiated at a temperature in the range of from 20° C. to 80° C.

The chain lengths of the polymers, in particular in the outer hard phase, may be adjusted by polymerizing the monomer mixture in the presence of molecular weight regulators. In particular known mercaptans can be used for this purpose, such as n-butyl mercaptan, n-dodecyl mercaptan, 2-mercaptoethanol or 2-ethylhexyl thioglycolate or pentaerythritol tetrathioglycolate. Typically, the amount of molecular weight regulator is from 0.05 to 5% by weight, based on the monomer mixture, preferably from 0.1 to 2% by weight and particularly preferably from 0.2 to 1% by weight, based on the monomer mixture. Preferably, n-dodecyl mercaptan is used as molecular weight regulator.

It is moreover possible to use salts, acids and bases in the emulsion polymerization, in particular to adjust the pH or to buffer the reaction mixture. For example, sulfuric acid, phosphoric acid, solutions of sodium hydroxide, potassium hydroxide, sodium salts and potassium salts of carbonates, bicarbonates, sulfates and/or phosphates (e.g. tetrasodium pyrophosphate) can be used. Typically, the emulsion polymer latex obtained in step (i) has a pH value in the range of 2 to 7, preferably 2.5 to 6.

Typically, the emulsion polymer latex obtained in step (i) has a solid content in the range of 20 to 60% by weight, based on the total weight of emulsion polymer latex. If necessary, the solid content can be adjusted.

### Ion Exchanging Step (ii)

The inventive method for producing the impact modifier comprises contacting the latex obtained in step (i) with an ion exchange material, preferably a cation exchange material, more preferably a strong acid cation exchange material, particularly in protonated form (H-form), in step (ii). Preferably, the amount of cationic metal ions is reduced to 1.0 mmol/kg or less after the ion exchanging step. Afterwards the latex is typically coagulated without the addition of ions (i.e. salts and/or acids), preferably without the addition of cations, such as alkali metal salts and alkaline earth metal salts.

Generally, the ion exchange material used in step (ii) may be at least one cation exchange material (i.e. material encompassing anionic groups, that can be loaded with protons H+) and/or at least one amphoteric exchange material (i.e. material encompassing anionic groups as well as cationic groups) and optionally at least one anion exchange material (i.e. material encompassing cationic basic groups). Different ion exchange materials may be used as mixture in one contacting step with the emulsion polymer latex and/or successively in two or more contacting steps with the emulsion polymer latex. For example, it is possible to contact the latex obtained in step (i) with an anion exchange material in a first step and to contact the latex with a cation exchange material in a second step afterwards. Furthermore, the use of mixed ion exchange materials, comprising anion and cation exchange groups, is possible.

Preferably, at least one cation exchange material is used, more preferably as the sole ion exchange material, in case that the emulsion polymerisation in step (i) is carried out in the presence of an anionic surfactant.

In order to avoid coagulation of the latex and clogging of the ion exchange material a non-ionic surfactant can be added in the ion exchange step (ii). In a preferred embodiment at least one non-ionic surfactant is added to the latex before and/or during ion exchanging step (ii). Particularly, the coagulation of the latex might occur if an anionic stabilized latex (i.e. a latex prepared via emulsion polymerisation using an anionic surfactant) is brought in contact with an anion exchange material. Suitable non-ionic surfactants are for example alkyl aryl polyethoxy alcohols, and alkyl polyethoxy alcohols, such as p-octylphenol-oxethylate (TRITON® X 100, Rohm & Haas) or fatty alcohol (GENAPOL X 080, Clariant GmbH). Typically, the non-ionic surfactant is added in an amount of 0.001 to 3.0% by weight, based on the solid content of the emulsion polymer latex. Such ion exchange steps are for example described in WO 2001/57100 A1, WO 99/62830 A and WO 99/62858 A.

In a preferred embodiment, the latex obtained in step (i) is brought in contact with at least one cation exchange material, more preferably a strong acid cation exchange material, particularly in protonated form (H-form), in step (ii). Suitable cation exchange materials comprise at least one acidic group, such as carboxylic acid groups (—COOH) or sulfonic acid groups (—S(═O)₂OH), preferably strong acid groups, such as sulfonic acid groups. In case that the cation exchange material is not in the protonated form, e.g. in Na-form, the cation exchange material can be treated with an aqueous acid solution, such as hydrochloric acid or sulfuric acid, in order to obtain the protonated H-form of the exchange material. Suitable examples of commercially available cation exchange materials are ion exchange resins manufactured by Dow Chemical Co. under the tradenames/trademarks DOWEX® MARATHON C, DOWEX® MONOSPHERE C-350, DOWEX® HCR-S/S, DOWEX® MARATHON MSC, DOWEX® MONOSPHERE 650C, DOWEX® HCR-W2, DOWEX® MSC-1, DOWEX® HGR NG (H), DOWEX® DR-G8, DOWEX® 88, DOWEX® MONOSPHERE 88, DOWEX® MONOSPHERE C-600 B, DOWEX® MONOSPHERE M-31, DOWEX® MONOSPHERE DR-2030, DOWEX® M-31, DOWEX® G-26 (H), DOWEX® 50W-X4, DOWEX® 50W-X8, DOWEX® 66; ion exchange resins manufactured by Rohm and Haas, under the tradenames/trademarks Amberlyst® 131, Amberlyst® 15, Amberlyst® 16, Amberlyst® 31, Amberlyst® 33, Amberlyst® 35, Amberlyst® 36, Amberlyst® 39, Amberlyst® 40 Amberlyst® 70, Amberlite® FPC11, Amberlite® FPC22, Amberlite® FPC23; ion exchange resins manufactured by Brotech Corp., under the tradenames/trademarks Purofine® PFC150, Purolite® C145, Purolite® C150, Purolite® C160, Purofine® PFC100, Purolite® C100; and ion exchange resins manufactured by Thermax Limited Corp., under the tradename/trademark Monoplus™ S100 and Tulsion® T42. Other acidic cation exchange resins known to those skilled in the art may also be used. Preferably, Dowex® Marathon C, from Dow Chemical is used.

Further, it is possible to contact the latex obtained in step (i) with at least one anion exchange material, preferably in addition to contacting the latex with a cation exchange material. In this way, it is typically possible to reduce the amount of anions, e.g. sulphur containing anions, to 6.5 mmol/kg or less (calculated as sulfate). Preferably, at least one non-ionic surfactant is added before and/or during step (ii), if an anion exchange material is utilized and if an anionic stabilizes emulsion polymer latex is utilized.

Typically, weakly, medium and strongly basic anion exchange material can be used. Typically, the basic group can be selected from primary amino groups (—NH₂), secondary amino groups (—NHR) and tertiary amino groups (—NR₂), wherein the basic capacity increases in this order from weakly to medium. Typically, the functional group of anion exchange materials can be selected from quaternary ammonium groups (also referred to as Quat). Suitable anion exchange materials comprise at least one functional cationic group, such as trimethylamine group, trimethylbenzyl ammonium group, or quaternary ammonium. In case that the anion exchange material is not loaded with hydroxy ions (i.e. in the Cl-form), the anion exchange material can be treated with an aqueous basic solution, such as sodium hydroxide solution or potassium hydroxide solution, in order to obtain the deprotonated form (OH-form) of the exchange material. Suitable examples of commercially available anion exchange materials are resins of DOWEX® 1×2, 1×4 and 1×8 series (Dow Chemical), resins of type AMBERLITE IRA 402, OAMBERJET 4200 (Rohm and Haas), OPUROLITE A 845 (Purolite GmbH), LEWATIT MP-500 (Bayer AG).

In step (ii) the latex obtained in step (i) is brought in contact with the at least one ion exchange material in any suitable way. For example, the ion exchanging step (ii) can be carried out by dispersion of the ion exchange material in the latex or in a column ion exchange step.

According to an embodiment, ion exchanging step (ii) can be carried out as a batch process by adding the ion exchange material to the latex in a stirred vessel and stirring the dispersion. After this treatment the ion exchange material is typically removed from the latex, e.g. by filtration.

According to another embodiment, ion exchanging step (ii) is carried out as a column ion exchange process, preferably continuously. Typically, in said embodiment the latex obtained in step (i) is passed through a column packed with the ion exchange material. Typically, the latex can be passed through the column by any means known from chromatographic procedure, e. g. gravity feed, static siphon or an automatic pumping system. Typically, the elution rate is 2 to 10 (occasionally up to 46) times the bed volume/hour. Typical mass flow rates are from 1.0 to 10 g/min.

Preferably, the ion exchanging step (ii) is carried out using the latex obtained in step (i), having a solid content in the range of 20 to 60% by weight, based on the total weight of latex, and/or having a pH value in the range of 2 to 7, preferably 2.5 to 6. If necessary, the solid content of the latex obtained in step (i) can be reduced to 10 to 30% by weight, preferably to less than 20% by weight, before ion exchange step, in particular in order to avoid coagulation of the latex. If necessary, the pH value might be adjusted before ion exchange step depending on the selected ion exchange material.

Coagulation and Mechanical Dewatering Step (iii)

The inventive method encompasses the coagulation and dewatering, preferably mechanical dewatering, in step (iii), wherein the latex obtained in step (ii) is coagulated by means of physical coagulation, preferably selected from shear coagulation, thermal shear coagulation, spray drying, freeze coagulation and pressure coagulation, more preferably by means of freeze coagulation, shear coagulation or thermal shear coagulation, and wherein a dewatered alkyl (meth)acrylate emulsion polymer is obtained, comprising less than or equal to 4.5 mmol/kg, preferably less than or equal to 3.0 mmol/kg, more preferably less than or equal to 1.0 mmol/kg, based on the solid content of the alkyl (meth)acrylate emulsion polymer, of alkali metal ions.

According to the present invention “coagulation by physical means” or “physical coagulation” means agglomeration and precipitation of the polymer particles in the emulsion polymer latex by applying a physical process, wherein typically the repulsive forces between the polymer particles, that effect the separation and stabilisation of the polymer particles in the latex, are reduced. Whereas, “chemical coagulation” means agglomeration and precipitation of the polymer particles in the emulsion polymer latex by adding a chemical agent (coagulant), that typically effects partly or wholly neutralization of stabilizing charges located at the polymer particles.

According to the inventive method for producing the poly(meth)acrylate impact modifier the coagulation is carried out by means of physical coagulation. Further, it might be advantageous to add at least one coagulant before and/or during coagulation, for example a salt of a multivalent metal ion.

The coagulation can also be effected without adding ionic species, preferably without adding cationic metal ions.

The physical coagulation of the emulsion polymer latex may be carried out by spray drying, coagulation by freezing (e.g. described in WO 2015/07488), or by mechanical and/or thermal stressing, in particular using a degassing extruder (e.g. described in WO 2002/18453, EP-A 0 979 162, EP-A 0 683 028).

Typically, the pH value of the coagulation mixture during the coagulation step (iii) is in the range of 3 to 8, preferably 2 to 7, more preferably 3 to 5, also preferably 2 to 4.

It is possible to add at least one salt of a multivalent metal ion, preferably selected from alkaline earth metals, zinc and aluminium, as coagulants in the coagulation step (iii). For example, suitable alkaline earth metal salts here are magnesium sulfate (such as kieserite (Mg[SO₄]·H₂O), pentahydrite (Mg[S04]·5H₂O), hexahydrite (Mg[S04]·6H₂O), and epsomite (Mg[S04]·7H₂O, Epsom salt)), magnesium chloride, calcium chloride, calcium hydroxide, calcium acetate, calcium formate, magnesium formate or mixtures thereof. For example, suitable aluminium salts are aluminium sulfate (Al₂(SO₄)₃), aluminium sulfate hydrates, aluminium chloride (AlCl₃), aluminium chloride hydrates, aluminium chlorohydrate, and polyaluminum chloride. For example, suitable zinc salts are zinc chloride (ZnCl₂), zinc sulfate (ZnSO₄), zinc sulfate hydrates (e.g. ZnSO₄·7H₂O) and zinc oxalate.

Dewatering of the coagulated latex can be carried out via mechanical dewatering (for example centrifugation and/or filtration) and/or via thermally dewatering (for example by evaporation of the aqueous phase of the emulsion polymer, e.g via spray drying). Further, it is possible to carry out the coagulation and dewatering of the emulsion polymer latex in one step, e.g. in case of spray drying or in case of coagulation and dewatering in a degassing extruder.

Preferably, dewatering of the coagulated emulsion polymer is carried out via mechanical dewatering, for example by means of centrifugation, decantation, or filtration. Preferably, the coagulated emulsion polymer is dewatered by means of batch-wise or continuously centrifugation. The coagulated emulsion polymer is typically centrifuged for a period of from 90 seconds to 10 minutes.

According to another embodiment of the invention the dewatering of the coagulated emulsion polymer is carried out by means of a degassing extruder, in particular in at least one dewatering zone of the extruder used for shear coagulation or thermal shear coagulation of the emulsion polymer.

Typically, the dewatered emulsion polymer obtained in step (iii) has a water content of less than or equal to 40% by weight, preferably in the range of 2 to 35% by weight, more preferably of 5 to 20% by weight.

The water content (also termed residual moisture content) of the multistage emulsion polymer after dewatering is the content of water in percent by weight, based on the moist polymer obtained after dewatering. The water content is in particular determined with the aid of suitable analysis equipment (e.g. drying and weighing devices), where the sample is dried until constant weight of the sample is achieved over a defined period. By way of example, the water content of the emulsion polymer can be determined in a moisture analyser, wherein the sample is dried at a temperature in the range of 80 to 180° C. In particular the water content may be determined using a Halogen Moisture Analyzer from Mettler Toledo at 160° C. until constant weight has been achieved for 30 seconds.

Preferably, the dewatered alkyl (meth)acrylate emulsion polymer obtained in dewatering step (iii) or after optionally washing step (iv) comprises less than or equal to 4.5 mmol/kg, preferably less than or equal to 3.0 mmol/kg, more preferably less than or equal to 1.0 mmol/kg, of alkali metal ions (e.g. sodium and/or potassium), and preferably, less than or equal to 20.0 mmol/kg, preferably less than or equal to 10.0 mmol/kg, based on the solid content of the impact modifier, of cationic metal ions, each based on the solid content of the emulsion polymer.

### Optional Sintering

In particular, step (iii) of the inventive process encompasses a sintering step after coagulation and before dewatering of the emulsion polymer.

Preferably, step (iii) may encompass a sintering step, wherein the coagulated multistage alkyl (meth)acrylate emulsion polymer can be maintained at a sintering temperature (Tₛ) near or below the glass transition temperature T_{g} of the outer phase/outer shell of the multistage alkyl (meth)acrylate emulsion polymer. Preferably, the optional sintering step is carried out after coagulation and before dewatering. In particular, the optional sintering step is carried out at a temperature Tₛ≥T_{g}−50 K, preferably Tₛ≥T_{g}−30 K, more preferably T_{g}−15 K5 Tₛ≤T_{g}+5 K.

Preferably, the coagulation mixture is kept at a temperature (sintering temperature) in the range of 60° C. to 140° C., preferably 70° C. to 135° C., more preferably 75° C. to 130° C. after coagulation of the emulsion polymer. In particular the coagulated emulsion polymer is kept at said sintering temperature T₂ for a period of 2 minutes to 24 hours, preferably 2 to 15 minutes, preferably 3 to 10 minutes, more preferably 5 to 10 minutes.

In a preferred embodiment the coagulated emulsion polymer may be treated with steam after coagulation during sintering step.

In a preferred embodiment the coagulated emulsion polymer may be diluted with water before sintering step. For example, the volume of the coagulated emulsion polymer composition may be increase by an factor of 1.5 to 5, preferably 2 to 4, via addition of water before sintering.

The method for producing the poly(meth)acrylate impact modifier may comprise one or both of the optional steps:
(iv) optionally washing of the dewatered alkyl (meth)acrylate emulsion polymer;
(v) optionally drying of the dewatered alkyl (meth)acrylate emulsion polymer obtained in step (iii) or (iv).

### Optional Washing Step (iv)

In a preferred embodiment, the mechanical dewatering of the emulsion polymer in step (iii) is followed by a washing step (iv), where the dewatered emulsion polymer is preferably treated with water or with a mixture of water and a polar, water-miscible organic solvent. The water or the mixture is preferably removed by filtration or centrifugation after the treatment. Preferably, in a downstream washing step (iv) the emulsion polymer is obtained with water content of less than or equal to 40% by weight, preferably in the range of 2 to 35% by weight, more preferably of 5 to 20% by weight.

For example, the washing step (iv) can be carried out by addition of water or a mixture of water and a polar, water-miscible organic solvent during the centrifugation, in particular in a continuous centrifugation process.

Preferably, the dewatered emulsion polymer obtained after an optional washing step (iv) exhibits the amounts of alkali metal ions and of multivalent metal ions, such as alkaline earth metal ions, zinc ions or aluminium ions, as described above for the dewatered emulsion polymer obtained after step (iii).

### Optional Drying Step (v)

The inventive method for producing the poly(meth)acrylate impact modifier may encompass one or more optional drying steps (v).

For example, the dewatered emulsion polymer can be dried by hot drying gas, e.g. air, or by means of a pneumatic dryer. Drying can for example be carried out in a cabinet dryer or other commonly known drying apparatus, such as flash dryer or fluidized bed dryer. Typically, the optional drying step (v) is carried out at a temperature in the range of 50 to 160° C., preferably from 55 to 155° C., particularly preferably from 60 to 150° C.

In another embodiment the coagulated and dewatered emulsion polymer is dried within a degassing extruder, in particular in an additional degassing sections of an extruder used for coagulation and dewatering.

Typically, the dried emulsion polymer obtained has a water content below 5%, preferably below 2%, preferably in the range from 0.05 to 2% by weight, preferably from 0.1 to 1.5% by weight, particularly preferably from 0.1 to 1% by weight.

Preferably, the dried emulsion polymer, for example obtained as powder or granulate, exhibit the same amounts of cationic metal salts, such as alkali metal ions and multivalent metal ions, such as alkaline earth metal ions, zins ions and aluminium ions, as the dewatered and optionally washed emulsion polymer obtained after step (iii) or (iv).

In a preferred embodiment of the invention in step (iii) the coagulation is carried out by means of freeze-coagulation and the mechanical dewatering of the coagulated emulsion polymer is carried out by means of centrifugation, wherein the water content of the dewatered emulsion polymer is less than or equal to 40% by weight, based on the dewatered emulsion polymer, and wherein the method comprises
(iv) optionally washing the dewatered alkyl (meth)acrylate emulsion polymer;
(v) drying the dewatered alkyl (meth)acrylate emulsion polymer obtained in step (iii) or (iv), wherein the poly(meth)acrylate impact modifier is obtained as a polymer powder.

According to another preferred embodiment of the invention, in step (iii) the coagulation and the mechanical dewatering is carried out by means of thermal shear coagulation, wherein the latex obtained in step (ii) is introduced into an extruder line, which comprises at least one coagulation zone, at least one dewatering zone and at least one degassing zone, wherein the poly(meth)acrylate impact modifier is obtained as a polymer granulate.

Furthermore, the method for producing the poly(meth)acrylate impact modifier may comprise the optional step of
(vi) adding one or more additives to the multiphase alkyl (meth)acrylate emulsion polymer.

Appropriate conventional additives can be admixed in each stage of the inventive method for producing the poly(meth)acrylate impact modifier, e.g. before or during dewatering of the coagulated emulsion polymer. Among them are dyes, pigments, stabilizers, lubricants, UV-protective agents, etc.

The optional additive may be selected from commonly known additives and/or auxiliaries for plastic materials. With respect to conventional auxiliaries and additives, reference is made by way of example to “Plastics Additives Handbook”, Hans Zweifel 6th Edition, Hanser Publ., Munich, 2009. For example, the at least one additive may be selected from fillers, reinforcing agents, dyes, pigments, lubricants or mould-release agents, stabilizers, in particular light and heat stabilizers, antioxidants, UV absorbers, plasticizers, impact modifiers, antistatic agents, flame retardants, bactericides, fungicides, optical brighteners, and blowing agents.

For example, the impact modifier may comprise 0 to 15% by weight, preferably 0 to 10% by weight, more preferably 0.5 to 5% by weight, based on the solid content of impact modifier, of at least one additive as mentioned above.

Thermoplastic Moulding Composition and Method for its Production In another aspect the present invention is directed to a thermoplastic moulding composition (also referred to as moulding composition in the following) comprising the inventive poly(meth)acrylate impact modifier and optionally at least one resin based on thermoplastic (meth)acrylate polymers. For example, such impact modified poly(meth)acrylate moulding compositions are described in WO 2004/056893.

In particular, the thermoplastic moulding composition comprises (preferably consists of):
1 to 100% by weight, preferably 5 to 100% by weight, based on the total moulding composition, of at least one poly(meth)acrylate impact modifier as described above;
0 to 99% by weight, preferably 0 to 95% by weight, based on the total moulding composition, of at least one thermoplastic (meth)acrylate polymer, preferably at least one poly(methyl methacrylate), and
0 to 50% by weight, preferably 0 to 10% by weight, based on the total moulding composition, 0 to 10% by weight, based on the total moulding composition, of one or more additive, preferably two or more additives, for example selected from UV absorbers, UV stabilizers, heat stabilizers, antioxidants, lubricants, dyes, and processing agents; and/or one or more additional polymeric component.

Typically, the thermoplastic (meth)acrylate polymer here preferably comprises (preferably consist of), based in each case on its total weight,
from 50.0 to 100.0% by weight, preferably from 60.0 to 100.0% by weight, particularly preferably from 75.0 to 100.0% by weight, in particular from 85.0 to 99.5% by weight, of alkyl methacrylate monomers (respectively repeat units) having from 1 to 20, preferably from 1 to 12, more preferably from 1 to 8, in particular from 1 to 4, carbon atoms in the alkyl radical,
from 0.0 to 40.0% by weight, preferably from 0.0 to 25.0% by weight, in particular from 0.1 to 15.0% by weight, of alkyl acrylate monomers (respectively repeat units) having from 1 to 20, preferably from 1 to 12, advantageously from 1 to 8, in particular from 1 to 4, carbon atoms in the alkyl radical, and
from 0.0 to 30% by weight, preferably 0.0 to 8.0% by weight of styrenic monomers (respectively repeat units).

Particularly, the thermoplastic (meth)acrylate polymer comprises, based on its total weight, at least 50.0% by weight, advantageously at least 60.0% by weight, preferably at least 75.0% by weight, in particular at least 85.0% by weight of methyl methacrylate.

For example, the moulding composition may comprise one or more additive and/or one or more additional polymeric component selected from dyes, pigments and cross-linked polymer beads.

In a preferred embodiment the inventive thermoplastic moulding composition as described above comprises up to 50% by weight, preferably 0.0001% to 50% by weight, based on the total thermoplastic moulding composition, of at least one dye and/or pigment, for example selected from perinone dyes, quinophthalone dyes, anthraquinone dyes, azo dyes, inorganic pigments, phthalocyanine pigments, and carbon black.

Further, the inventive thermoplastic moulding composition as described above may comprise 0.01% to 50% by weight, based on the total thermoplastic moulding composition, of at least one cross-linked polymer beads, preferably selected from cross-linked polymer beads (scattering beads) having a different refractive index compared to the refractive index of the polymer matrix formed by thermoplastic moulding composition. Suitable cross-linked polymer beads are described below.

Typically, the thermoplastic (meth)acrylate polymer has a number-average molar mass in the range from 1000 to 100,000,000 g/mol, preferably in the range from 10 000 to 1,000,000 g/mol, in particular in the range from 50 000 to 500 000 g/mol. This molar mass may be determined by gel permeation chromatography, for example, with calibration based on polymethylmethacrylate.

Furthermore, the invention is directed to a method for producing the thermoplastic moulding composition, wherein the components, typically in the form of their melts or in the form of powders or pellets, are mixed and homogenized, for example in a single screw or multi screw extruder or on a roll mill.

In particular the method for producing the thermoplastic moulding composition comprises:
xi) mixing 5 to 100% by weight, based on the total moulding composition, of at least one inventive poly(meth)acrylate impact modifier as described above; 0 to 95% by weight, based on the total moulding composition, of at least one thermoplastic (meth)acrylate polymer; and optionally 0 to 10% by weight, of one more additive and/or one or more additional polymeric component; and
xii) melt compounding of the mixture obtained in step xi), preferably at a temperature in the range of 200 to 280° C.

Conventional additives may be admixed at any processing stage suitable for this purpose. These include dyes, pigments, fillers, reinforcing fibres, lubricants, UV stabilizers, organic or inorganic scattering particles etc.

Further, the present invention is directed to moulded articles or semi-finished products, such as foils, films or sheets, produced from the thermoplastic moulding composition as described above.

The thermoplastic moulding compositions can be used for the production of moulded articles of any type, and semi-finished products, such as sheets, films, fibres foams etc. Processing may be carried out using the known processes for thermoplastic processing, in particular production may be carried out via thermoforming, (co-)extruding, injection moulding, calendaring, blow moulding, compression moulding, press sintering, deep drawing or sintering, preferably by injection moulding.

### Moulded Article or Semi-Finished Product

The present invention is also directed to a moulded article or semi-finished product produced from the inventive thermoplastic moulding composition as described above.

For example, the moulded article or semi-finished product may comprise the inventive thermoplastic moulding composition as described above and additionally one or more additive as described above and/or one or more additional polymeric component, for example the additive may be selected from dyes, pigments and cross-linked polymer beads.

Preferably, the moulded article or semi-finished product comprises up to 50% by weight, preferably 0.0001% to 50% by weight, based on the total moulded article or semi-finished product, of at least one additive, preferably selected from dyes, pigments, organic scattering particles (in particular cross-linked polymer beads as described below) and inorganic scattering particles.

Preferably, the moulded article or semi-finished product comprises up to 50% by weight, preferably 0.0001% to 50% by weight, based on the total moulded article or semi-finished product, of at least one dye and/or pigment, preferably selected from perinone dyes, quinophthalone dyes, anthraquinone dyes, azo dyes, inorganic pigments, phthalocyanine pigments, and carbon black.

Preferably, the moulded article or semi-finished product comprises 0.01% to 50% by weight, based on the total moulded article or semi-finished product, of at least one organic or inorganic scattering particles, preferably selected from cross-linked polymer beads, more preferably selected from cross-linked polymer beads (scattering beads) having a different refractive index compared to the refractive index of the polymer matrix formed by thermoplastic moulding composition.

In a preferred embodiment the semi-finished product is a film or sheet.

In a preferred embodiment the moulded article or semi-finished product is transparent. In particular the moulded article or semi-finished product has a haze value of less than or equal to 30.0%, preferably of less than or equal to 20.0%, more preferably of less than or equal to 10%, in particular of less than or equal to 6.0%, measured by means of a BYK Gardner Hazegard-plus hazemeter in accordance with ASTM D1003-13 for material thicknesses of 40 μm-1000 μm determined after water storage at 80° C. for 4 h-24 h. In particular the moulded article or semi-finished product has a haze value, determined after water storage at 80° C. for 24 h, measured at 23° C. on test specimen having a thickness of 1 mm according to standard ASTM D1003 (2013), of less than or equal to 40.0%, preferably less than or equal to 30%, more preferably less than or equal to 25.0%, also preferably less than or equal to 20.0%.

In particular the moulded article or semi-finished product is produced by providing the thermoplastic moulding composition as described above and adding at least one additive; in particular selected from dyes, pigments and cross-linked polymer beads as described above, and mixing the thermoplastic moulding composition and the art least one additive, preferably via melt compounding, e.g. during film formation process or injection moulding process.

Typically, said dye and/or pigment can be added to the inventive thermoplastic moulding composition as described above in form of a colouring preparation, a liquid composition or masterbatch comprising said colouring preparation.

In some embodiments of the present invention, the moulding composition may comprise organic or inorganic scattering particles dispersed in the matrix of the polymer. The low haze value after hot water storage of the inventive impact modified thermoplastic moulding compositions may be advantageous in combination with scattering particles as well, because a more homogenous opaque and matt appearance, even after hot water storage, can be obtained. Although the choice of the scattering particles is not particularly limited, they are typically selected in such a way that the refractive index of the scattering particles differs from that of the copolymer matrix by at least 0.01. The refractive index can be measured at the Na D-line at 589 nm at 23° C. as specified in the standard ISO 489 (1999).

The scattering particles usually have a weight average particle diameter of from 0.01 μm to 100.0 μm. The weight average particle diameter—indicated as so-called volume averaged d₅₀-value (that is 50 percent by volume of the particles have a particle size below the specified average particle size) of the scattering particles can be measured in accordance with the standard for laser diffraction measurements ISO 13320-1 (2009). Typically, the size of the scattering particles is determined by laser light scattering, e.g. at room temperature, 23° C., using Beckman Coulter LS 13 320 laser diffraction particle size analyser.

Inorganic scattering particles may include traditional inorganic opacifiers, e.g. barium sulphate, calcium carbonate, titanium dioxide or zinc oxide.

Organic scattering particles are typically spherical scattering beads consisting of a cross-linked polymeric material such as poly alkyl(meth) acrylates, silicones, polystyrenes etc. Preferably, at least 70%, particularly at least 90%, of scattering beads, based on the number of scattering beads, are spherical.

Preferred scattering beads composed of crosslinked polystyrenes are commercially available from Sekisui Plastics Co., Ltd. with the trademarks Techpolymer® SBX-4, Techpolymer® SBX-6, Techpolymer® SBX-8 and Techpolymer® SBX-12.

Other particularly preferred spherical plastics particles which are used as scattering agents comprise cross-linked silicones. Silicone scattering agents particularly preferably used in the present invention are obtainable from Momentive Performance Materials Inc. as TOSPEARL® 120 and TOSPEARL® 3120.

The invention is described in more detail by the following examples and claims.

### EXAMPLES

The emulsion polymer EP1 (examples 1-7), having a core-shell structure, as well as the emulsion polymers EP2 (examples 8-9) and EP3 (examples 10-12) having a core-shell-shell structure were prepared and freeze coagulated. According to inventive examples the emulsion polymer latex were conveyed through an ion exchange material before freeze coagulation.

### 1. Preparation of PMMA Latex Emulsion Polymers

### Examples 1-6: Core-Shell Emulsion Polymer EP1

In a polymerization vessel equipped with stirrer, feeding vessel and external cooling a water phase containing sodium hydroxymethylsulfate, acetic acid, iron (II) sulfate (FeSO4) and an aqueous solution of seed latex, with 5% by weight solid content, was placed.

At a temperature of 55° C. (vessel outside temperature) emulsion I as described in table 1 was added sequentially over a time period of 20 min. After 10 min emulsion II as described in table 1 was added sequentially within 2 h. The reaction mixture was stirred for 60 min, cooled to 45° C. and filtered over VA-steel (mesh size 90 μm). The emulsion I was obtained by emulsifying the monomers and components as indicated in table 1.

The amounts are summarized in the following table 1.

TABLE 1
Emulsion polymerization of latex emulsion polymer
EP 1, all amounts given in parts by weight

| | EP1 |
|---|---|
| Water phase | |
| Water | 1564.80 |
| Acetic acid | 0.20 |
| FeSO₄ | 0.004 |
| Na hydroxymethanesulfinate | 2.73 (in 40 parts by weight water) |
| Seed | 250.00 |
| Emulsion I | |
| Water | 732.95 |
| Tert-Butylhydroxyperoxide | 0.92 |
| Hostapur ® SAS 30 | 2.67 |
| Irganox ® 1076 | 0.93 |
| Butylacrylate | 911.48 |
| Allylmethacrylate | 18.60 |
| Emulsion II | |
| Water | 1459.90 |
| Tert-butyl hydroxyperoxide | 1.83 |
| Hostapur ® SAS 30 | 4.02 |
| Irganox ® 1076 | 1.86 |
| 1-Dodecanethiol | 14.68 |
| Butyl acrylate | 148.63 |
| Methyl methacrylate | 1709.29 |

Hostapur® SAS 30 (Clariant): Sodium C14-17 alkyl secondary sulfonate Irganox® 1076 (BASF): sterically hindered phenolic antioxidant

The aqueous polymer dispersion EP1 obtained had a solid content of 40-42% by weight and an average particle diameter of about 124 nm, determined by laser light scattering, at room temperature, 23° C., using Beckman Coulter LS 13 320 laser diffraction particle size analyser.

### Examples 7-9: Core-Shell-Shell Emulsion Polymer EP2

In a polymerization vessel equipped with stirrer, feeding vessel and external cooling a water phase containing acetic acid, iron (II) sulfate (FeSO₄) and seed, containing 10 percent by weight of PMMA, was placed. At a temperature of 52° C. (vessel outside temperature) emulsion I as described in table 2 was added over a time period of 1 hour. In parallel 0.69 g sodium metabisulfite in 20 g water was added (during the first 10 min).

After 15 min, 1.94 parts by weight of sodium metabisulfite in 100 parts by weight water was added within 10 min parallel to the start of the addition of emulsion II as described in table 2. Emulsion II (table 2) was added within 2 h followed by a 50 mi break. Emulsion III as described in table 2 was added simultaneously with 0.62 parts by weight sodium metabisulfite in 50 parts by weight water. The addition of sodium metabisulfite was finished within 10 min, emulsion III after 1 h. Afterwards the reaction mixture was stirred for 30 min, cooled to 35° C. and filtered over VA-steel (mesh size 100 μm).

The emulsions I, II and III were each obtained by emulsifying the monomers and components as indicated in table 2.

TABLE 2
Emulsion polymerization of latex emulsion polymers
EP2, all amounts given in parts by weight

| | EP2 |
|---|---|
| Water phase | |
| Water | 1691.00 |
| Acetic acid | 0.10 |
| FeSO₄ | 0.0034 |
| Seed | 5.30 |
| Emulsion I | |
| Water | 732.69 |
| Sodium peroxodisulfate | 0.51 |
| Aerosol OT 75 | 4.67 |
| Ethyl acrylate | 29.40 |
| Methyl methacrylate | 703.47 |
| Allymethacrylate | 2.21 |
| Emulsion II | |
| Water | 628.65 |
| Sodium peroxodisulfate | 1.44 |
| Aerosol OT 75 | 7.46 |
| Butyl acrylate | 1218.72 |
| Allymethacrylate | 19.53 |
| Styrene | 262.87 |
| Emulsion III | |
| Water | 381.56 |
| Sodium peroxodisulfate | 0.44 |
| Aerosol OT 75 | 1.34 |
| Ethyl acrylate | 38.35 |
| Methyl methacrylate | 920.45 |
| 1-Dodecanethiol | 3.36 |

Aerosol OT 75: aqueous solution (75%) of sodium dioctyl sulfosuccinate

The aqueous polymer dispersions EP2 obtained had a solid content of 46-48% by weight and an average particle diameter of about 340 nm, determined by laser light scattering, at room temperature, 23° C., using Beckman Coulter LS 13 320 laser diffraction particle size analyser.

### Examples 10-12: Core-Shell-Shell Emulsion Polymer EP3

In a polymerization vessel equipped with stirrer, feeding vessel and external cooling water, sodium carbonate and seed, containing 10 percent by weight of PMMA, was placed. At a temperature of 83° C. (vessel inside temperature) emulsion I as described in table 3 was added over a time period of 90 minutes (10 minutes addition, 10 minutes break, 80 minutes addition). After a 10 min break, the addition of emulsion II as described in table 3 was started. Emulsion II was added within 2 h followed by a 30-45 min break. Emulsion III was added within 1 h. Afterwards the reaction mixture was stirred for 30 min, cooled to room temperature (approx. 30 min) and filtered over VA-steel (mesh size 100 μm).

The emulsions I, II and III were each obtained by emulsifying the monomers and components as indicated in table 3.

TABLE 3
Emulsion polymerization of latex emulsion polymers
EP 3, all amounts given in parts by weight

| | EP 3 |
|---|---|
| Water phase | |
| Water | 1711.00 |
| Acetic acid | — |
| FeSO₄ | — |
| Seed | 20.00 |
| Sodium carbonate | 1.37 |
| Emulsion I | |
| Water | 785.92 |
| Sodium peroxodisulfate | 0.70 |
| Aerosol OT 75 | 5.60 |
| Ethyl acrylate | 47.60 |
| Methyl methacrylate | 1140.02 |
| Allymethacrylate | 2.38 |
| Emulsion II | |
| Water | 542.39 |
| Sodium peroxodisulfate | 1.58 |
| Aerosol OT 75 | 7.20 |
| Butyl acrylate | 1234.71 |
| Allymethacrylate | 22.95 |
| Styrene | 272.34 |
| Emulsion III | |
| Water | 361.32 |
| Sodium peroxodisulfate | 0.70 |
| Aerosol OT 75 | 1.08 |
| Ethyl acrylate | 26.52 |
| Methyl methacrylate | 653.48 |
| 1-Dodecanethiol | — |

Aerosol OT 75: aqueous solution (75%) of sodium dioctyl sulfosuccinate

The aqueous polymer dispersion EP3 obtained had a solid content of 49-51% by weight and an average particle diameter of about 250 nm, determined by laser light scattering, at room temperature, 23° C., using Beckman Coulter LS 13 320 laser diffraction particle size analyser.

### II. Ion Exchange

The aqueous polymer dispersions of examples 3-6 (core-shell emulsion polymers EP1), of examples 8 and 9 (core-shell-shell emulsion polymers EP2) and of examples 11 and 12 (core-shell-shell emulsion polymers EP3) were subjected to an ion exchange step before coagulation as described in the following.

For examples 3, 5, 6 and 9 a glass column with an internal diameter of 16 mm was filled with 25 mL of a strongly acidic cation exchanger provided in protonated form (H-form) (Dowex® Marathon C, from Dow Chemical). The free volume above the ion exchanger bed was then filled manually with the respective dispersion. Subsequently, the dispersion was pumped through the column from top to bottom at a mass flow rate of 3.7 g/min (example 3); 2.5 g/min (example 5); 2.4 g/min (example 6) or 3.5-5 g/min (example 9).

For examples 4, 8 and 12 a glass column with an internal diameter of approx. 50 mm was filled with approx. 200 mL of a strongly acidic ion exchanger (Dowex® Marathon C, from Dow Chemical). The free volume above the ion exchanger bed was then filled manually with the respective dispersion. Subsequently, the dispersion was passed through the column applying slight pressure of nitrogen.

For examples 5.1, 5.2 and 11 a stainless-steel column with an internal diameter of 107 mm was filled with 1000 mL of a strongly acidic ion exchanger (Dowex Marathon C). The free volume above the ion exchanger bed was then filled manually with the respective dispersion. Subsequently, the dispersion was pumped through the column from top to bottom at a mass flow rate of 285 g/min (examples 5.1 and 5.2) or 230-240 g/min (example 11).

The procedures for examples 1-12 are summarized in table 4.

Samples were taken at regular intervals at the column outlet and analysed for their sodium content via AAS.

### III. Freeze Coagulation, Sintering and Dewatering

The aqueous polymer dispersions of examples 1-10 and 12 (partly after ion exchange treatment) were frozen at −18° C. for 24 h. Afterwards the mixture was sintered at 80° C. for 24 h. The latex was cooled to room temperature and the particles were separated from the water via centrifugation at 1800 rpm. The centrifugation time was varied between 1.5-10 min resulting in different residual water content (w(H₂O)) in the coagulated and dewatered emulsion polymer. In examples 4, 8, and 12 instead of centrifugation, the polymer was separated from the water via vacuum filtration.

After centrifugation or filtration, the polymer was washed with deionized water and again centrifuged or filtrated. This procedure was carried out three times and the resulting polymer powder was dried at 50° C. for approx. 16-48 h to obtain a final water content of <1%. Test specimens with a thickness of 1 mm were prepared from said dried material as described below.

For examples 5.1, 5.2 and 11 the outlet of the ion exchanger column (as described above) was continuously fed into a continuous flake ice machine (HIGEL HEC400) and continuously frozen at a roller temperature of −20° C., roller speed was 1.2 rpm and fill level was 140 mm. The resulting ice was subsequently transferred to a 5 L continuously stirred tank reactor (CSTR), mixed with 110 g/min water (ambient temperature); 150 g/min and steam (160° C.) and continuously thawed at a temperature of 85° C.-95° C. The outlet of the CSTR was collected and centrifuged batchwise for 10 min. at 2800 rpm. The resulting dewatered polymer was then dried in an oven at 46° C. for 96 h (examples 5.1 and 11) or 72 h (example 5.2).

The procedures for examples 1-12 are summarized in table 4.

The water content (w(H₂O)) after centrifugation was determined using an electronic moisture analyser (Sartorius MA45). The results are given in the tables below.

The content of metal ions (e.g. sodium content, calcium content and magnesium content) of the dewatered and dried impact modifiers (emulsion polymers) of examples 1 to 12 were determined as described below. The results are summarized in tables below.

TABLE 4
Ion exchanging step and coagulation step

| | | | | Bed | Flow | |
|---|---|---|---|---|---|---|
| | | Ion | | volume | rate | Freeze coagulation/ |
| Ex. | EP | exchanger | Column | ml | g/min | separation |
| 1 | 1 | — | — | — | — | Batch/centrifugation |
| 2 | 1 | — | — | — | — | Batch/centrifugation |
| 3* | 1 | MC | Glass | 25 | 3.7 | Batch/centrifugation |
| 4* | 1 | MC | Glass | 200 | n.d. | Batch/filtration |
| 5* | 1 | MC | Glass | 25 | 2.5 | Batch/centrifugation |
| 5.1* | 1 | MC | Stainless steel | 1000 | 285 | Continuous |
| 5.2* | 1 | MC | Stainless steel | 1000 | 285 | Continuous |
| 5.3 | 1 | MC | Glass | 25 | 2.5 | Batch/centrifugation/ |
| | | | | | | addition of CaAc2 |
| 6* | 1 | MC | Glass | 25 | 2.4 | Batch/centrifugation |
| 7 | 2 | — | — | — | — | Batch/centrifugation |
| 8* | 2 | MC | Glass | 200 | n.d | Batch/filtration |
| 9* | 2 | MC | Glass | 25 | 3.5-5 | Batch/centrifugation |
| 10 | 3 | — | — | — | — | Batch/centrifugation |
| 11* | 3 | MC | Stainless steel | 1000 | 230-240 | Continuous |
| 12* | 3 | MC | Glass | 200 | n.d. | Batch/filtration |

*Inventive example
MC: Dowex Marathon C
n.d. not determined

### Iv. Preparation of Moulding Compositions and Test Specimen

Test specimens of 1 mm thickness and a diameter of 5 cm were prepared by hot pressing the polymer powders EP1 according to examples 1-6, which were obtained as described above. The impact modifiers (polymer powders) according to examples 7-12 (based on emulsion polymers EP2 and EP3) were blended with PMMA_1 (copolymer of about 96 wt.-% methylmethacrylate (MMA) and 4 wt.-% methylacrylate having a weight averaged molecular weight of about Mw=110.000) wherein the amount of impact modifier (w_{IM}) is given in the tables below. The polymer blend was prepared in an Haake Rheomix 5000 at a temperature of 220-230° C. (30 rpm). The resulting melt was removed from the chamber and crushed with pliers. Test specimens of 1 mm thickness and a diameter of 5 cm were prepared by hot pressing of the granulates.

Further, film of 53 μm were produced via extrusion. Haze and transmittance of the said films were measured as described below.

### V. Results

The haze values and the transmission of the test specimens (1 mm) and films (53 μm) were determined as described below. The results are summarized in tables below.

The water content in the emulsion polymer obtained after coagulation and dewatering is indicated as w(H2O). The amount of the impact modifier (emulsion polymer) in the moulding compositions respectively in the test specimen used for haze and transmission is indicated as w(IM) given in % by weight. The amounts of metal ions and sulphur (calculated as sulfate) in the impact modifier (dried emulsion polymer) are given as mmol/kg(impact modifier).

Tables 5-6 (examples 1 to 6) contain the results for core-shell emulsion polymer EP1 being partially processed via acidic ion exchanger, freeze coagulation and mechanical dewatering.

Tables 7-8 summarize the results for core-shell-shell emulsion polymers EP2 (examples 7-9) and EP3 (examples 10-12) being partially processed via acidic ion exchanger, freeze coagulation and mechanical dewatering and subsequently blended with PMMA_1.

TABLE 5
Test results examples 1-6/ion content, transmittance and haze (test specimens, 1 mm)

| | | | | | | Haze | | | Transm. | | |
|---|---|---|---|---|---|---|---|---|---|---|---|
| | | W_{IM} | W_{H2O} | m_{Na} | | (80° C., 1 mm) | | | (80° C., 1 mm) | | |
| Ex. | EP | kg/kg | kg/kg | mmol/kgIM | m_{S} | 0 h | 24 h | Δ | 0 h | 24 h | Δ |
| 1 | 1 | 100% | 6% | 5.2 | 2.9 | 2% | 53% | 51% | | | |
| 2 | 1 | 100% | 12% | 5.2 | 6.0 | — | — | — | — | — | — |
| 3* | 1 | 100% | 8% | <0.9 | 3.9 | 2% | 42% | 40% | — | — | — |
| 4* | 1 | 100% | — | <0.9 | 2.6 | 4% | 32% | 28% | — | — | — |
| 5* | 1 | 100% | 20% | <0.9 | 6.1 | 2% | 23% | 21% | 94% | 86% | 8% |
| 5.1* | 1 | 100% | n.a. | <0.9 | 3.2 | 2% | 26% | 24% | 93% | 88% | 6% |
| 5.2* | 1 | 100% | n.a. | <0.9 | 4.7 | 2% | 25% | 23% | 93% | 87% | 6% |
| 6* | 1 | 100% | 10% | <0.9 | 4.0 | — | — | — | — | — | — |

*Inventive example

According to Example 5.3 (see table 5a) an aqueous solution of calcium acetate (CaAc2) (coagulant), was added to emulsion polymers EP1 after ion exchange step. Ion exchange, coagulation and dewatering was carried out as described for example 5 (see section III. above). It is demonstrated that the haze after hot water storage can further improved by addition of specific amount of a calcium salt as coagulation auxiliary agent.

TABLE 5a
Test results examples 1, 5 and 5.3/Ion content and
haze (test specimens, 1 mm)

| | | Ca_{added} | | | m_{Na} | m_{ca} | Haze | | |
|---|---|---|---|---|---|---|---|---|---|
| | | mol_{Ca}/ | W_{IM} | W_{H2O} | mmol/ | | (80° C., 1 mm) | | |
| Ex. | EP | mol_{Na} | kg/kg | kg/kg | kg_{IM} | | 0 h | 24 h | Δ |
| 1 | 1 | — | 100% | 6% | 5.2 | — | 2% | 53% | 51% |
| 5* | 1 | — | 100% | 20% | <0.9 | — | 2% | 23% | 21% |
| 5.3* | 1 | 1.0 | 100% | 17% | <0.9 | 8.0 | 2% | 4% | 2% |

*inventive example

TABLE 6
Test results examples 1-6/Transmittance and Haze (films, 53 μm)

| | | W_{IM} | Haze (80° C., 53 μm) | | | Transm. (80° C., 53 μm) | | |
|---|---|---|---|---|---|---|---|---|
| Ex. | EP | kg/kg | 0 h | 4 h | Δ | 0 h | 4 h | Δ |
| 2 | 1 | 100% | 0.9% | 18.4% | 17.5% | — | — | — |
| 5.1* | 1 | 100% | 1.1% | 1.6% | 0.5% | 94.1% | 93.6% | 0.5% |
| | | W_{IM} | Haze (80° C., 53 μm) | | | Transm. (80° C., 53 μm) | | |
| Ex. | EP | kg/kg | 0 h | 24 h | 4 | 0 h | 24 h | Δ |
| 5.2* | 1 | 100% | 1.1% | 7.9% | 6.8% | 93.1% | 93.0% | 0.1% |
| 6* | 1 | 100% | 1.6% | 3.4% | 1.8% | 94.3% | 93.0% | 1.3% |

*Inventive example

TABLE 7
Test results examples 7-9/Ion content, transmittance and haze (test specimens, 1 mm)

| | | W_{IM} | W_{H2O} | m_{Na} | m_{S} | Haze (80° C., 1 mm) | | | Transm. (80° C., 1 mm) | | |
|---|---|---|---|---|---|---|---|---|---|---|---|
| Ex | EP | kg/kg | | mmol/kg_{IM} | | 0 | 24 h | Δ | 0 | 24 h | Δ |
| 7 | 2 | 36% | 10% | 6.1 | 2.6 | 3% | 75% | 72% | — | — | — |
| 8* | 2 | 36% | 13% | <0.9 | 0.0 | 2% | 19% | 17% | 93% | 84% | 9% |
| 9* | 2 | 36% | 24% | <0.9 | 0.0 | 1% | 24% | 23% | 93% | 86% | 7% |

*Inventive example

TABLE 8
Test results examples 10-12/Ion content, transmittance and haze (test specimens, 1 mm)

| | | | | | | Haze | | | Transm. | | |
|---|---|---|---|---|---|---|---|---|---|---|---|
| | | W_{IM} | W_{H2O} | m_{Na} | m_{S} | (80° C., 1 mm) | | | (80° C., 1 mm) | | |
| Ex. | EP | kg/kg | | mmol/kg_{IM} | | 0 | 24 h | A | 0 | 24 h | 4 |
| 10 | 3 | 33% | 12% | 11.3 | 1.9 | 3% | 59% | 56% | 91% | 78% | 14% |
| 11* | 3 | 33% | 22% | <0.9 | 0.0 | 2% | 29% | 27% | 93% | 84% | 9% |
| 12* | 3 | 33% | 20% | <0.9 | 0.0 | 3% | 8% | 5% | 92% | 88% | 4% |

*Inventive example

It is shown that improved hot water storage stability in view of the haze value as well as transmission is obtained if the amount of metal ions, in particular sodium ions, is reduced to less than 4.5 mmol/kg, preferably to less than 1 mmol/kg.

### VI. Test Methods

### A. Hot Water Haze

The test specimens (obtained by hot pressing, having 1 mm thickness and a diameter of 5 cm) were stored in deionized water at 80° C. for 24 hours. Haze values were determined before and after hot water storage according to ASTM D1003-13 using a Hazemeter BYK Gardner haze-gard i.

These test specimens which were prepared as described above were tested with a BYK Gardner haze-gard i haze meter at 23° C. in accordance with the ASTM D1003-13 in the original state (“Haze before”) and after hot water storage in deionized water at 80° C. for 24 hours. It should be noted that—according to ASTM D1003-13—materials having a haze value greater than 30% are considered “diffusing” and should be tested in accordance with Practice for Goniometric Optical Scatter Measurements (E2387). Since the focus of the current work is on transparent materials having haze value less than 30%, the haze values greater than 30% are reported in order to illustrate tendencies.

These haze values and the difference (HAZE/Δ) of haze value after and before hot water storage (HAZE/24 h-HAZE/0 h) are summarized in the tables above.

The transmission (given in %) before and after hot water storage was determined accordingly in accordance with the ASTM D1003-13.

### B. Content of Metal Ions

In order to determine the metal ion content (e.g. Na and Ca) a microwave-assisted digestion of the dried emulsion polymer with nitric acid was performed. Afterwards the content of the relevant ions was determined via atomic absorption spectroscopy.

In order to determine the sulfate content of the modifiers, the polymer was digested via the Wickbold method. Afterwards the sulphur content was determined using ion chromatography and the final sulfate (SO₄²⁻), content was calculated therewith. In the tables above amount of sulphur mₛ is given calculated as sulfate.

### C. Water Content

If not defined otherwise, the water content (residual water) was determined using an electronic moisture analyser heating up to 85° C. (Sartorius MA45).

1. A poly(meth)acrylate impact modifier comprising at least one multiphase alkyl (meth)acrylate emulsion polymer, wherein a total amount of alkali metal ions in the poly(meth)acrylate impact modifier is less than or equal to 4.5 mmol/kg, based on a solid content of the poly(meth)acrylate impact modifier.

2. The poly(meth)acrylate impact modifier according to claim 1, wherein the poly(meth)acrylate impact modifier comprises less than or equal to 20.0 mmol/kg, based on the solid content of the poly(meth)acrylate impact modifier, of cationic metal ions.

3. The poly(meth)acrylate impact modifier according to claim 1, wherein the at least one multiphase alkyl (meth)acrylate emulsion polymer is obtained by emulsion polymerization and comprises a core and at least one shell.

4. The poly(meth)acrylate impact modifier according to claim 1, wherein the at least one multiphase alkyl (meth)acrylate emulsion polymer comprises:
at least 10% by weight of at least one C₁-C₁₀ alkyl methacrylate;
5 to 80% by weight of at least one C₁-C₁₀ alkyl acrylate or at least one conjugated diene;
0 to 2% by weight of at least one crosslinking monomer; and
0 to 15% by weight of optionally further monomers.

5. The poly(meth)acrylate impact modifier according to claim 1, wherein the at least one multiphase alkyl (meth)acrylate emulsion polymer is a core-shell emulsion polymer, comprising:
A1) 10 to 95% by weight, based on a total core-shell emulsion polymer, of a soft elastomeric core A1, having a glass transition temperature T_{g} below −10° C., A1 comprising:
A1.1) 50 to 99.5% by weight, based on A1, of at least one C₁-C₁₀ alkyl acrylate;
A1.2) 0.5 to 5% by weight, based on A1, of at least one crosslinking monomer, having two or more ethylenically unsaturated groups;
A1.3) 0 to 10% by weight, based on A1, of at least one further ethylenically unsaturated, free radically polymerizable monomer; and
B1) 5 to 90% by weight, based on the total core-shell emulsion polymer, of a hard shell B1, having a glass transition temperature T_{g} above 70° C., B1 comprising:
B1.1) 80 to 100% by weight, based on B1, of at least one C₁-C₆ alkyl methacrylate; and
B1.2) 0 to 20% by weight, based on B1, of at least one further ethylenically unsaturated, free radically polymerizable monomer.

6. The poly(meth)acrylate impact modifier according to claim 1, wherein the at least one multiphase alkyl (meth)acrylate emulsion polymer is a core-shell emulsion polymer, comprising:
A2) 5 to 40% by weight, based on the total core-shell emulsion polymer, of a hard, non-elastomeric core A2, having a glass transition temperature T_{g} above 50° C., A2 comprising
A2.1) 80 to 100% by weight, based on A2, of at least one C₁-C₆ alkyl methacrylate;
A2.2) 0 to 20% by weight, based on A2, of at least one further ethylenically unsaturated, free radically polymerizable monomer;
A2.3) 0 to 5% by weight, based on A1, of at least one crosslinking monomer, having two or more ethylenically unsaturated groups; and
B2) 20 to 75% by weight, based on the total core-shell emulsion polymer, of a soft elastomeric intermediate shell B2, having a glass transition temperature T_{g} below 0° C., B2 comprising:
B2.1) 45 to 99.5% by weight, based on B2, of at least one C₁-C₁₀ alkyl acrylate;
B2.2) 0.5 to 5% by weight, based on B2, of at least one crosslinking monomer, having two or more ethylenically unsaturated groups;
B2.3) 0 to 50% by weight, based on B2, of at least one further ethylenically unsaturated, free radically polymerizable monomer; and
C2) 15 to 60% by weight, based on the total core-shell emulsion polymer, of a hard outer shell C2, having a glass transition temperature T_{g} above 50° C., C2 comprising:
C2.1) 80 to 100% by weight, based on C2, of at least one C₁-C₆ alkyl methacrylate; and
C2.2) 0 to 20% by weight, based on C2, of at least one further ethylenically unsaturated free radically polymerizable monomer.

7. A method for producing a poly(meth)acrylate impact modifier according to claim 1 comprising at least one multiphase alkyl (meth)acrylate emulsion polymer, the method comprising:
(i) preparation of at least one multiphase alkyl (meth)acrylate emulsion polymer via emulsion polymerization, wherein the multiphase alkyl (meth)acrylate emulsion polymer is obtained in form of a latex;
(ii) removing cations and optionally anions in an ion exchange, wherein the latex obtained in (i) is brought in contact with an ion exchange material;
(iii) coagulation and dewatering of the latex obtained in (ii),
wherein the coagulation is carried out by physical coagulation,
wherein a dewatered alkyl (meth)acrylate emulsion polymer is obtained, and
wherein the dewatered alkyl (meth)acrylate emulsion polymer comprises less than or equal to 4.5 mmol/kg, based on a solid content of the poly(meth)acrylate impact modifier, of alkali metal ions.

8. The method according to claim 7, wherein at least one cation exchange material and/or at least one amphoteric exchange material and optionally at least one anion exchange material is used in the ion exchange (ii).

9. The method according to claim 7, wherein at least one non-ionic surfactant is added to the latex before and/or during the ion exchange (ii).

10. The method according to claim 7, wherein in (iii) the coagulation is carried out by freeze-coagulation and the dewatering of a coagulated emulsion polymer is carried out by centrifugation, wherein a water content of the dewatered emulsion polymer is in a range of 5 to 40% by weight, based on the dewatered alkyl (meth)acrylate emulsion polymer, and wherein the method comprises:
(iv) optionally washing the dewatered alkyl (meth)acrylate emulsion polymer;
(v) drying the dewatered alkyl (meth)acrylate emulsion polymer obtained in (iii) or (iv), wherein the poly(meth)acrylate impact modifier is obtained as a polymer powder.

11. The method according to claim 7, wherein in (iii) the coagulation and the dewatering is carried out by thermal shear coagulation, wherein the latex obtained in (ii) is introduced into an extruder line, the extruder line comprising:
at least one coagulation zone;
at least one dewatering zone; and
at least one degassing zone,
wherein the poly(meth)acrylate impact modifier is obtained as a polymer granulate.

12. A thermoplastic moulding composition, comprising:
1 to 100% by weight, based on the total thermoplastic moulding composition, of at least one poly(meth)acrylate impact modifier according to claim 1;
0 to 99% by weight, based on the total thermoplastic moulding composition, of at least one thermoplastic (meth)acrylate polymer; and
0 to 50% by weight, based on the total thermoplastic moulding composition of one or more additives and/or one or more additional polymeric components.

13. A method for producing a thermoplastic moulding composition according to claim 12, comprising:
xi) mixing 1 to 100% by weight, based on the total thermoplastic moulding composition, of at least one poly(meth)acrylate impact modifier;
to 99% by weight, based on the total thermoplastic moulding composition, of at least one thermoplastic (meth)acrylate polymer; and optionally 0 to 50% by weight, of one more additives and/or one or more additional polymeric components; and
xii) melt compounding of the mixture obtained in xi).

14. A moulded article or semi-finished product produced from a thermoplastic moulding composition according to claim 12.

15. The moulded article or semi-finished product according to claim 14, wherein the moulded article or semi-finished product comprises up to 50% by weight, based on the total moulded article or semi-finished product, of at least one additive selected from the group consisting of dyes, pigments, organic scattering particles and inorganic scattering particles.

16. The moulded article or semi-finished product according to claim 14, wherein the moulded article or semi-finished product has a haze value, determined after water storage at 80° C. for 24 h, measured at 23° C. on test specimen having a thickness of 1 mm according to standard ASTM D1003 (2013), of less than or equal to 40.0%.
